(19) United States
(12) Patent Application Publication
(10) Pub. No.: US 2003/0101091 A1
(43) Pub. Date: May 29, 2003

(54) System and method for interactive on-line performance assessment and appraisal

(76) Inventors: Burgess Levin, Reston, VA (US); Steven Drucker, Alexandria, VA (US)

Correspondence Address: COLLIER SHANNON SCOTT, PLLC, 3050 K STREET, NW, SUITE 400, WASHINGTON, DC, 20007, US

(21) Appl. No.: 10/183,627

(22) Filed: Jun. 28, 2002

Related U.S. Application Data
(60) Provisional application No. 60/301,459, filed on Jun. 29, 2001.

(51) Int. Cl. G06F 17/60

(52) U.S. Cl. 705/11

(57) ABSTRACT

The present invention is an on-line performance assessment, performance appraisal, objectives tracking, and training management system. The system consists of two main components: a front end which provides access to the application function to the end user; and a site administration end which provides a management interface for application administrators to add, delete, and modify records, settings, and preferences in the system as well as generate reports from the database. The present system enables users to perform various human resources functions, including, but not limited to, competency assessment, 360 feedback, multi-rater assessments, objectives tracking, performance appraisals, and training registration and tracking.

### CROSS-REFERENCE TO RELATED APPLICATIONS

The present invention relates to, and is entitled to the benefit of the earlier filing date and priority of, U.S. Provisional Application Serial No. 60/301,459, filed Jun. 29, 2001.

### FIELD OF THE INVENTION

The invention relates to a system for performing human resource functions in an interactive database. More specifically, the present invention enables users to enter data, access, and prepare performance assessments and performance appraisals in a secure database environment.

### BACKGROUND OF THE INVENTION

Organizations rate the performance of individuals within the organization in order to accurately and appropriately monitor performance, reward good performers, and provide development assistance, training, or counseling to individuals to improve their performance. Generally, these performance assessment and appraisal systems are “paper” based and cumbersome, resource intensive, and time consuming. Prior known interactive systems are limited to providing for the staffing of various projects, or for the timing and reporting of projects. The Applicant is not aware of a an interactive method or system to interactively monitor the performance of individuals within an organization on an ongoing basis.

The Applicant is aware of several performance appraisal software programs such as: Performance Now; Peoplesoft 17; Abratrak; and Ivantage. These software programs provide various aspects of performance assessment and appraisal but do not address many of the problems cited above. These software packages are routinely managed within the human resources department of an organization and are not available to employees. In many instances, prior known systems and processes provide forms which may be printed out for use during performance appraisals and assessments. The programs assist human resource departments in comparing performance among individuals but do not facilitate or support the performance review process within the organization as a whole.

Castonguay, et al., U.S. Pat. No. 5,911,134, entitled “Method for Planning, Scheduling and Managing Personnel,” issued Jun. 8, 1999 (“astonguay”) discloses computerized systems and methods for planning, scheduling, and managing personnel. Castonguay is adapted to a work environment in which there is a varying workload by time of day and by day of week, requiring staffing with a variable number of workers. Castonguay enables the scheduling and management of personnel during certain times of anticipated workloads. Castonguay does not enable comparisons of performance between employees or measurement of particular accomplishments or goals achieved by employees or groups of employees. Rather, Castonguay gauges the number of employees needed for a particular task at a particular time.

Merrill, et al., U.S. Pat. No. 5,954,510, entitled “Interactive Goal-achievement System and Method” issued Sep. 21, 1999 (“Merrill”), discloses a goal-achievement and learning system that improves an individual's ability to achieve measurable, self-determined goals over periods of time. Merrill uses interactive information exchange, feedback, and reinforcement. Merrill is a “teaching machine” that can take the place of a human teacher for a “one on one” mentoring situation. Merrill focuses on a simple, readily available method to collect data that provides feedback, reinforcement, and rewards necessary to motivate continued improvement. Merrill allows an individual to set specific goals, enter data regarding progress toward those goals, and to receive self-motivation to continue to reach the desired goals. Merrill, however, does not provide a process for evaluation or the ability to enter input, assessment, appraisal, or rating from third parties regarding an employee's performance.

Lautzenheiser, et al., U.S. Pat. No. 6,023,572, entitled “Computer Based System and Method for Modeling Activities of People in an Organization” issued Feb. 8, 2000 (“Lautzenheiser”), discloses a computer based modeling arrangement, and more particularly modeling the processes, procedures, and information exchanged and provided by people in an organization. Lautzenheiser models the processes performed by the organization, information exchanged by the processes, and events that caused the initiation of the processes, Lautzenheiser can be used by persons within the organization to streamline processes and identify duplication of work. Lautzenheiser does not, however, provide the ability to evaluate or appraise individual employees' contribution towards goals or evaluate their value to the organization as compared to others.

Donnelly, et al., U.S. Pat. No. 6,049,776, entitled “Human Resources Management System for Staffing Projects” issued Apr. 11, 2000 (“Donnelly”), discloses a “Resource Management System” (RMS), having a server and database containing files storing information on employees, employee skills, employee schedules, and projects. Donnelly includes a calendar for maintaining the scheduled activities of employees with different types of scheduled activities and also a resource search and scheduling functionality that identifies human resources possessing the required skills and availabilities for assignments to projects. The parameters that are entered into the database include information such as time requirements for the project, skill requirements, and proficiency levels.

The system of Donnelly assigns identified employees to the projects and updates the system calendar to reflect the project assignments. Donnelly is directed to staffing complex projects within a corporate environment. Donnelly considers parameters such as skill sets and levels, duration of the project, time constraints, locations, schedules, and commitments of the numerous resources that may provide candidates for fulfilling the requirements of any given project. Donnelly is a computer-implemented system for staffing projects in accordance with a search for required personnel skill sets and schedule availability, for assigning personnel to a project. Donnelly integrates further search parameters such as location, training, and willingness to travel.

Donnelly provides a resource management system and method for identifying candidate human resources to be assigned to a project where the project requires predetermined skills and predetermined time availability. Donnelly does not, however, provide any form of performance evaluation, assessment, appraisal, or determination of the achievement of certain goals of any employee.

Barney, et al., U.S. Pat. No. 6,070,143, entitled “System and Method for Analyzing Work Requirements and Linking Human Resource Products to Jobs” issued May 30, 2000 (“Barney”), discloses a computer-based system and method for assessing work requirements relating to jobs and linking human resource products to the assessed jobs. Barney compiles work-oriented information, for instance, on aspects of work performed (tasks, roles, environment) and attributes of a worker that are required to successfully perform the work (knowledge, skills, abilities). Barney's system and method operates a computer to perform job placement analysis, essentially to match the requirements of the job with the skill level of an applicant. Barney, however, does not evaluate job performance conduct, appraisals, or measure the success of any particular employee or applicant.

Human resource functions of organizations have been frustrated in the methods available to assess and appraise performance of employees within their organizations. Typical systems, as shown in FIG. 3, were paper-based. A number of problems existed with these paper-based systems, among them:

non-compliance with deadlines;

failure to conduct face-to-face performance reviews with the employee;

the quality of the appraisal and feedback are highly variable even between comparable employees;

the supervisor or manager is free to express objectives in any terms, which could be, for example, vague, harsh, inappropriate, and inconsistent;

inaccuracy of performance reviews due to delayed time between employee behavior and the review—performance assessment and appraisal is not an on-going process in that reviews usually occur at most every six months, wherein a behavior could be remote from the actual feedback received; possibility of surprise to the employee due to a lag between the time of the behavior and the review—a review six months after the fact may not be fair due to the time that has passed between the behavior and the actual review;

guidance may not be provided to the employee ahead of time regarding job or role expectations, the employee is not exposed to the expected objectives other than during a review;

the possibility of vast differences within the organization of what is expected of employees with roughly the same positions, roles, or responsibilities;

lack of or lack of access to developmental tools to improve performance or further develop the employee as needed and separation of the performance review and assessment process from the necessary development training process;

lack of integration between behaviors noted for improvement, and availability of recommended training; and

the review process takes a long time and is resource intensive.

Therefore, there continues to be a substantial unmet need for a performance assessment and appraisal system to overcome these problems.

The present invention overcomes the shortcomings of prior known systems and provides a simple method for interactively assessing and appraising the performance of individuals in real time and overtime within an organization, monitoring their progress, and creating interactive reviews and reports, as well as recommending training on-line in a database, network, and/or a web-based environment. The present invention represents a paradigm shift and solves many of the problems that have plagued previous systems. Two features of the system and method of the present invention help resolve many of these needs: 1) employee on-line performance assessment, at the behavioral level, and appraisals as an ongoing process with access to availability of development activities and resources, which eliminates many of the problems with prior art systems; and 2) integration and tracking of employee performance against objectives. The system and method of the present invention overcomes many of the problems with previously known systems, and makes the employee performance assessment and appraisal process both more efficient and effective.

In one embodiment, the present invention is based on competencies, objectives, roles and behaviors. The present invention uses natural language throughout the system and in all descriptions of behaviors, objectives, and competencies. The present invention also preferably includes a control vocabulary to eliminate or reduce the risk of inappropriate descriptions. The invention makes performance assessment, appraisal, and review much easier to complete and, as such, increases compliance with the performance management process within the organization. The present invention allows one to record, in real time, the behaviors and accomplishments of an employee and associate them with a rating scale. This enables the organization and its managers to provide more effective, closely linked feedback, coaching, and development opportunities while enabling the employee to take more ownership of their own development. The system and method according to an embodiment of the present invention also allows tracking and integration of employee behaviors, accomplishments, and training expectations.

Prior known systems do not generally provide: an evaluation process where there is substantial appraisal input or rating from third parties regarding an individual's performance; the ability to evaluate or appraise an individual employee's contribution towards predetermined goals; the ability to match competencies and objectives and provide assessments in an on-line web-based, database, and/or network environment; and the ability to evaluate individuals relative to other similarly situated individuals within an organization. The present invention overcomes many problems associated with various paper-based systems, prior known patented systems, and individual software products which do not provide the ability for performance assessment in an on-line web-based, database, and/or network environment.

It is therefore an advantage of the present invention to provide an improved method and system for assessing performance on-line, in a web-based database, and/or network environment.

It is also an advantage of the present invention to provide a method and system for managing performance appraisal information on-line in a web-based database and/or network environment.

It is still a further advantage of the present invention to provide a method and system for facilitating compliance with performance assessment and appraisal requirements and deadlines.

It is another advantage of the present invention to standardize the quality of assessments, appraisals, and feedback.

It is still yet another advantage of the present invention to provide a method and system for providing real time performance tracking, appraisal and assessment of behaviors on-line in a web-based environment.

It is also an advantage of the present invention to provide a method and system for expected competencies and objectives in real time on-line, in a web-based environment.

It is still a further advantage of the present invention to provide a method and system for standardizing competencies and objectives within similar roles within an organization.

It is another advantage of the present invention to provide a method and system for enabling any number of employees to evaluate the performance of a particular employee on-line, in a web-based environment.

It is still yet another advantage of the present invention to provide a method and system for communicating performance assessment and appraisal information to selected employees on-line, in a web-based environment.

It is also an advantage of the present invention to provide a method and system for maintaining a calendar for training of employees on-line, in a web-based environment.

It is still a further advantage of the present invention to provide a method and system for assessing the need for specific training for any particular employee on-line, in a web-based environment.

It is another advantage of the present invention to provide a method and system for scheduling any particular employee or groups of employees for any specific training on-line in a web-based environment.

It is still another advantage of the present invention to compile comparative data about employee and organizational performance over time, enabling the business to make informed decisions about human capital management issues.

Additional advantages of the invention are set forth, in part, in the description which follows, and, in part, will be apparent to one of ordinary skill in the art from the description and/or from the practice of the invention.

### SUMMARY OF THE INVENTION

An embodiment of the present invention is a system for on-line performance assessment and appraisal, the system comprising competency means for defining competencies, objective means for defining objectives, and assessment means for assessing performance based on the competencies and the objectives on-line, in a web-based environment.

Another embodiment of the present invention is a system for on-line performance assessment and appraisal, the system comprising competency means for defining competencies, objective means for defining objectives, role means for defining the competencies based on roles, and assessment means for assessing performance based on the competencies, the objectives, and the roles on-line, in a web-based environment.

Another embodiment of the present invention is a system for on-line performance assessment and appraisal, the system comprising competency means for defining competencies, objective means for defining objectives, role means for defining the competencies based on roles, assessment means for assessing performance based on the competencies, the objectives, and the roles, and development means for defining development and training recommendations based on the competencies, the objectives, and the roles on-line, in a web-based environment.

Another embodiment of the present invention is a system for on-line performance assessment and appraisal, the system comprising competency means for defining competencies, objective means for defining objectives, role means for defining the competencies based on roles, assessment means for assessing performance based on the competencies, the objectives, and the roles, 360 feedback means for providing 360 performance reviews, and development means for defining the development and training recommendations based on the competencies, the objectives, and the roles on-line in a web-based environment.

Another embodiment of the present invention is a system for on-line performance assessment and appraisal, the system comprising competency means for defining competencies, wherein the competency means further comprises the ability of a user to add competencies, objective means for defining objectives, wherein the objective means further comprises the ability of a user to add objectives, role means for defining said competencies based on roles, assessment means for assessing performance based on said competencies, the objectives, and the roles, organizational chart means for defining users and their position within an organization, 360 feedback means for providing 360 performance reviews, and development means for defining development and training recommendations based on the competencies, the objectives, the roles on-line, in a web-based environment.

Another embodiment of the present invention is a method of on-line performance management comprising the steps of logging onto the system, inputting an individual, defining the individual's role, defining the individual's expected competencies, and defining the individual's objectives on-line in, a web-based environment.

As embodied herein an alternative embodiment of the present invention is a method of on-line performance management comprising competency means that are determined by selecting one or more criteria among the group including: role, position in the organization, or ad hoc by the addition of a user, assessment means that are determined by selecting one or more criteria among the group including: self-assessment, assessment by the manager or supervisor, assessment by matrix managers or supervisors, or 360 feedback assessments.

Another embodiment of the present invention is a method initiating a performance appraisal in an on-line performance management system comprising the steps of: selecting the competency assessment to include in the appraisal; reviewing the current status of performance objectives and any prior reports filed on the objectives; adding free-form comments on performance against competencies and objectives; adding the growth and development plan (by employee and manager); assigning final overall performance rating (by manager only); saving as draft or saving and sharing appraisal with employee/manager; printing the performance appraisal; and maintaining a database of appraisals that transfer with an employee as they move within an organization.

Another embodiment of the present invention is a method for establishing individual and team performance objectives in an online performance management system comprising the steps of: Inputting objectives; delegating objectives to direct reports; associating individual objectives with enterprise objectives; selecting success metrics for objectives; establishing task milestones to complete objectives; reporting status and progress of objectives of time at pre-determined intervals; maintaining a record of performance and accomplishments against objectives that carries forward into the appraisal process and database, and transfers with employees as they move within an organization.

Another embodiment of the present invention is a method of establishing and tracking a training plan for an employee in an online performance management system comprising the steps of: recommending training and development activities based on assessments and/or roles; scheduling employees for training; creating a transcript of employee training attendance, accomplishments or certifications over time; maintaining a record of employee training that transfers with an employee as they transfer to new managers or divisions.

It is to be understood that both the foregoing general description and the following detailed description are exemplary and explanatory only, and are not restrictive of the invention as claimed. The accompanying drawings, which are incorporated herein by reference, and which constitute a part of this specification, illustrate certain embodiments of the invention and, together with the detailed description, serve to explain the principles of the present invention.

### BRIEF DESCRIPTION OF THE DRAWINGS

FIGS. 1a and b are flow charts depicting the performance management system according to an embodiment of the present invention.

FIGS. 2a and b are flow charts depicting the performance management method according to an embodiment of the present invention.

FIG. 3 is a flow chart depicting a performance appraisal system according to the prior art.

FIG. 4 is a diagram of a screen print depicting the get employee function of an embodiment of the present invention.

FIG. 5 is a diagram of a screen print depicting the organization chart function of an embodiment of the present invention.

FIG. 6 is a diagram of a screen print depicting the user home page function of an embodiment of the present invention.

FIG. 7 is a diagram of a screen print depicting the preferences function of an embodiment of the present invention.

FIG. 8 is a diagram of a print screen depicting the role descriptions function of an embodiment of the present invention.

FIG. 9 is a diagram of a screen print depicting the role descriptions function with expanded lists of an embodiment of the present invention.

FIG. 10 is a diagram of a screen print depicting the objectives and accomplishments function of an embodiment of the present invention.

FIG. 11 is a diagram of a screen print depicting the user objective function of an embodiment of the present invention.

FIG. 12 is a diagram of a screen print depicting the reports due function of an embodiment of the present invention.

FIG. 13 is a diagram of a screen print depicting the performance assessment function for the current user of an embodiment of the present invention.

FIG. 14 is a diagram of a screen print depicting the performance assessment function accessed through the get employee function of an embodiment of the present invention.

FIG. 15 is a diagram of a screen print depicting the assessments in progress function of an embodiment of the present invention.

FIG. 16 is a diagram of a screen print depicting the assessments in progress with expanded lists function of an embodiment of the present invention.

FIG. 17 is a diagram of a screen print depicting the modify 360/multirater assessment configuration function of an embodiment of the present invention.

FIG. 18 is a diagram of a screen print depicting the 360 developmental assessment function showing one competency of an embodiment of the present invention.

FIG. 19 is a diagram of a screen print depicting the 360 developmental assessment function showing open-ended text questions of an embodiment of the present invention.

FIG. 20 is a diagram of a screen print depicting the save 360 assessment options function of an embodiment of the present invention.

FIG. 21 is a diagram of a screen print depicting the dual-rater assessment function of an embodiment of the present invention.

FIG. 22 is a diagram of a screen print depicting the dual-rater assessment function with one competency expanded for recording critical incidences of an embodiment of the present invention.

FIG. 23 is a diagram of a screen print depicting the select competencies function with elective list expanded of an embodiment of the present invention.

FIG. 24 is a diagram of a screen print depicting the save assessments options function of an embodiment of the present invention.

FIG. 25 is a diagram of a screen print depicting the print assessment function of an embodiment of the present invention.

FIG. 26 is a diagram of a screen print depicting the multi-rater appraisal compare function of an embodiment of the present invention.

FIG. 27 is a diagram of a screen print depicting the completed assessments function of an embodiment of the present invention.

FIG. 28 is a diagram of a screen print depicting the completed assessments function with expanded list of an embodiment of the present invention.

FIG. 29 is a diagram of a screen print depicting the overall competency roll up table in the 360 feedback report function of an embodiment of the present invention.

FIG. 30 is a diagram of a screen print depicting the itemized competency graphs in the 360 feedback report function of an embodiment of the present invention.

FIG. 31 is a diagram of a screen print depicting the itemized competency roll up table in the 360 feedback report function of an embodiment of the present invention.

FIG. 32 is a diagram of a screen print depicting the 360 feedback report open-ended response function of an embodiment of the present invention.

FIG. 33 is a diagram of a screen print depicting the 360 feedback report function in print window mode of an embodiment of the present invention.

FIG. 34 is a diagram of a screen print depicting the completed 360 feedback survey function of an embodiment of the present invention.

FIG. 35 is a diagram of a screen print depicting the completed 360 feedback survey function in print window mode of an embodiment of the present invention.

FIG. 36 is a diagram of a screen print depicting the select 360/multirater assessment participants function of an embodiment of the present invention.

FIG. 37 is a diagram of a screen print depicting the 360/multi-rater assessment competencies function of an embodiment of the present invention.

FIG. 38 is a diagram of a screen print depicting the online help system of an embodiment of the present invention.

FIG. 39 is a schematic flow diagram depicting the relationship of the software functions of the front-end function of an embodiment of the present invention.

FIG. 40 is a schematic flow diagram depicting the relationship of the software components of the organization chart function of an embodiment of the present invention to one another.

FIG. 41 is a schematic flow diagram depicting the relationship of the software elements of the home function of an embodiment of the present invention to one another.

FIG. 42 is a schematic flow diagram depicting the relationship of the software components of the roles function of an embodiment of the present invention to one another.

FIG. 43 is a schematic flow diagram depicting the relationship of the software components of the objectives and accomplishments module of an embodiment of the present invention to one another.

FIG. 44 is a schematic flow diagram depicting the relationship of the software components of the developmental feedback module of an embodiment of the present invention to one another.

FIG. 45 is a schematic flow diagram depicting the relationship of the software components modules of the list assessments in progress module of an embodiment of the present invention to one another.

FIG. 46 is a schematic flow diagram depicting the relationship of the software components of the list completed assessments module of an embodiment of the present invention to one another.

FIG. 47 is a schematic flow diagram depicting the relationship of the software elements of the track competency development module of an embodiment of the present invention to one another.

FIG. 48 is a schematic flow diagram depicting the relationship of the performance appraisal module in an embodiment of the present invention.

FIG. 49 is a schematic flow diagram depicting the relationship of the software components of the training calendar module of an embodiment of the present invention to one another.

FIG. 50 is a schematic flow diagram depicting the relationship of the software components of the reports made module of an embodiment of the present invention to one another.

FIGS. 51a and b is a schematic flow diagram depicting the relationship of the software components of the site administration module of an embodiment of the present invention to one another.

FIG. 52 depicts the interrelationship of the software components of the 360 feedback means of an embodiment of the present invention to one another.

FIG. 53 is a schematic flow diagram depicting the relationship of the software components of the initiate 360 feedback module of an embodiment of the present invention to one another.

FIG. 54 is a schematic flow diagram depicting the relationship of the software components of the respond to a request to fill out a 360 module of an embodiment of the present invention to one another.

FIG. 55 is a schematic flow diagram depicting the relationship of the software components of the review 360 feedback reports module of an embodiment of the present invention to one another.

FIG. 56 is a diagram of a screen print of site administrator interface of an embodiment of the present invention.

FIG. 57 is a diagram of a screen print depicting creation of organizations and divisions of an embodiment of the present invention.

FIG. 58 is a diagram of a screen print depicting creation and customization of rating scales forvarious assessment forms used within a division in an embodiment of the present invention.

FIG. 59 is a diagram of a screen print depicting how competency categories are established for a division of an organization in an embodiment of the present invention.

FIG. 60 is a diagram of a screen print depicting where competencies and behavioral descriptors are loaded for a division in an embodiment of the present invention.

FIG. 61 is a diagram of a screen print depicting where role families are established for a division in an embodiment of the present invention.

FIG. 62 is a diagram of a screen print depicting where competencies are defined by role for a division in an embodiment of the present invention.

FIG. 63 is a diagram of a screen print depicting where corporate or enterprise-level objectives are set in the site administration module of an embodiment of the present invention.

FIG. 64 is a diagram of a screen print depicting where progress labels are established for reporting work against objectives in an embodiment of the present invention.

FIG. 65 is a diagram of a screen print depicting where the status labels of objectives are entered in the objective status module of an embodiment of the present invention.

FIG. 66 is a diagram of a screen print depicting where the success metrics for objective measurement are entered in an embodiment of the present invention.

FIG. 67 is a diagram of a screen print depicting where administrators can generate division and/or organizational level reports in an embodiment of the present invention.

### DETAILED DESCRIPTION OF THE PREFERRED EMBODIMENT

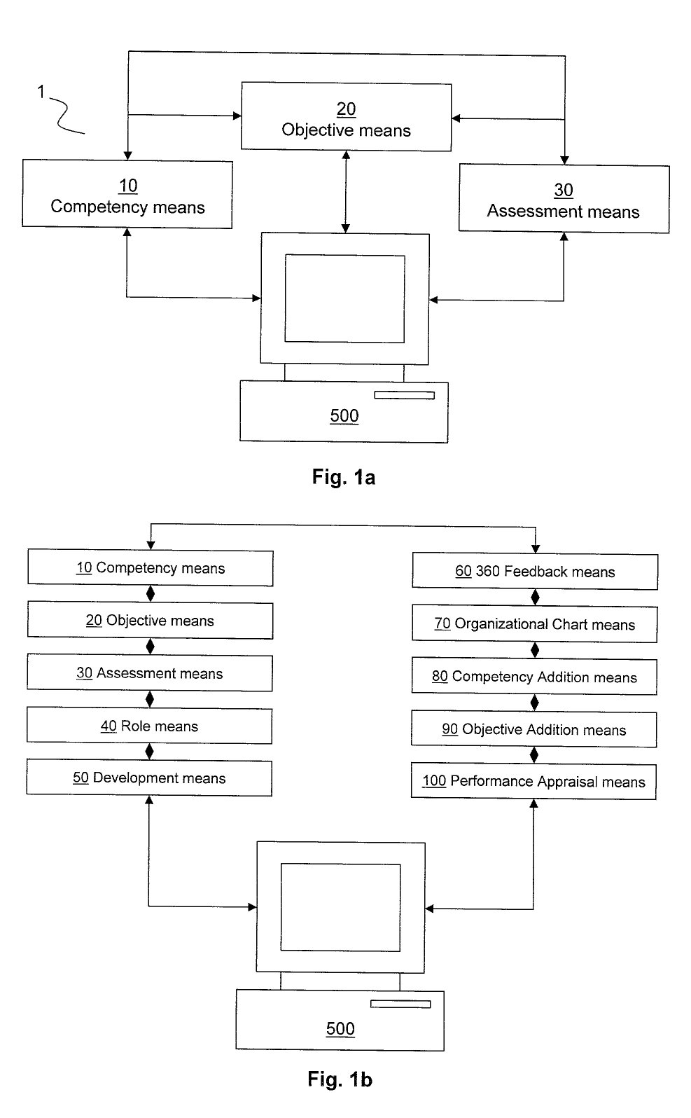

The present invention comprises a system and method for on-line performance assessment. An embodiment of the present invention is shown in FIG. 1a as system 1. System 1 comprises a competency means 10, an objective means 20, and an assessment means 30, in an on-line, web-based environment 500. An on-line web-based environment 500 is defined as any suitable database, hardware, software, network or application, including but not limited to, intranets, internets, or any other web-based environment available on a single computer, a network of computers, a local server, or on an intranet or on the internet and world-wide-web. Competency means 10 further comprises competencies of a user. Competency means may further comprise a database of various behavior traits and skills expected of employees. Objective means 20 further comprises objectives of a user. Objective means may further comprise a system whereby objectives can be assigned to a given employee by a manager, system administrator, or by addition by the employee. Assessment means 30 further comprises a performance assessment based on the defined competencies and the defined objectives on-line, in a web-based environment. Assessment means may further comprise the ability to initiate a self-assessment, the ability for a manager to initiate an assessment of an employee, the ability for either a manager or the employee to initiate a 360 performance review, and for those participating in the 360 feedback review to complete it, or the ability to initiate a matrix manager assessment.

FIG. 1b illustrates an alternative embodiment of the system according to the present invention comprising a competency means 10, objective means 20, assessment means 30, and role means 40, in an on-line, web-based environment. Role means 40 may further comprise defining the competencies based on an individual's role or position within the organization. Role means 40 may further comprise a database of roles of employees within the organization including, but not limited to: executive, manager, technician, supervisor, and/or other roles appropriate to the organization.

Another alternative embodiment of the system according to the present invention comprises competency means 10, objective means 20, assessment means 30, role means 40, and development means 50 on-line, in a web-based environment. Development means 50 may define development and training recommendations for an individual based on the competencies and the roles on-line in a web-based environment. Development means 50 may comprise a database of developmental tools, including, but not limited to, course listings, training calendar, and training schedules.

An alternative embodiment of the system according to the present invention comprises competency means 10, an objective means 20, assessment means 30, role means 40, development means 50, and 360 feedback means 60. 360 feedback means 60 provides means for a user to initiate 360 assessments, for a supervisor or manager to initiate assessments, for a matrix manager to initiate assessments, and/or to facilitate 360 assessments.

An alternative embodiment of the system according to the present invention comprises: competency means 10, objective means 20, assessment means 30, role means 40, development means 50, 360 feedback means 60, organizational chart means 70, competency addition means 80, and objective addition means 90. Organizational chart means 70 preferably provides means to view, select, and modify the position of a user relative to other individuals within a division or an organization. Competency addition means 80 provides a means for the user to add competencies to a competency assessment or 360 feedback survey. Objective addition means 90 provides a means for the user to add performance objectives.

An alternative embodiment of the system according to the present invention comprises: competency means 10, objective means 20, assessment means 30, role means 40, development means 50, 360 feedback means 60, organizational chart means 70, competency addition means 80, objective addition means 90, and performance appraisal means 100. Performance appraisal means 100 may comprise a means for an employee and manager to configure an appraisal by selecting the dual rater assessment to be used, adding comments about performance on competencies and objectives, and creating a development plan for the next review period.

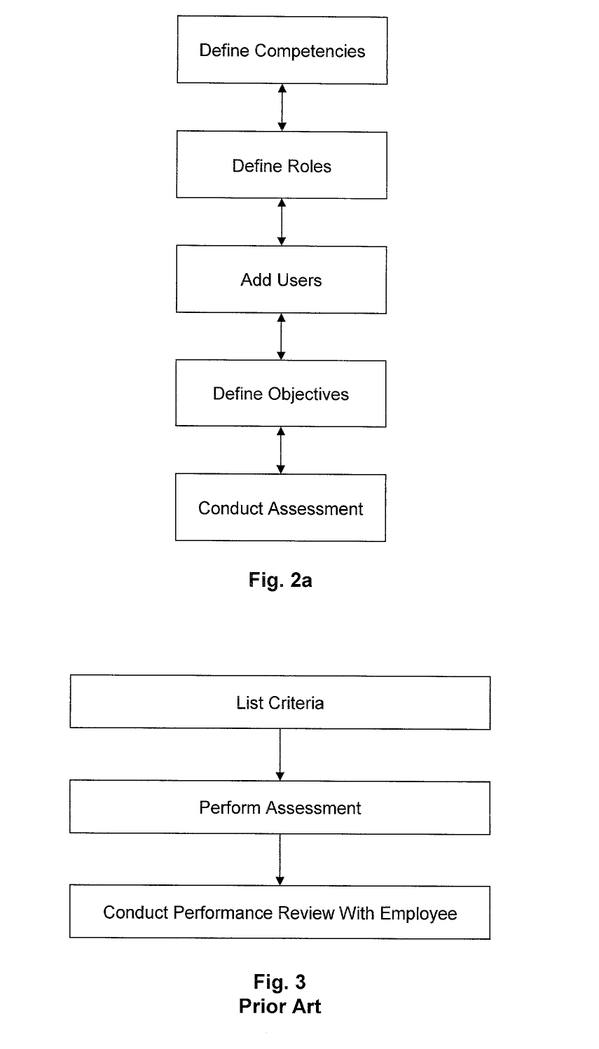

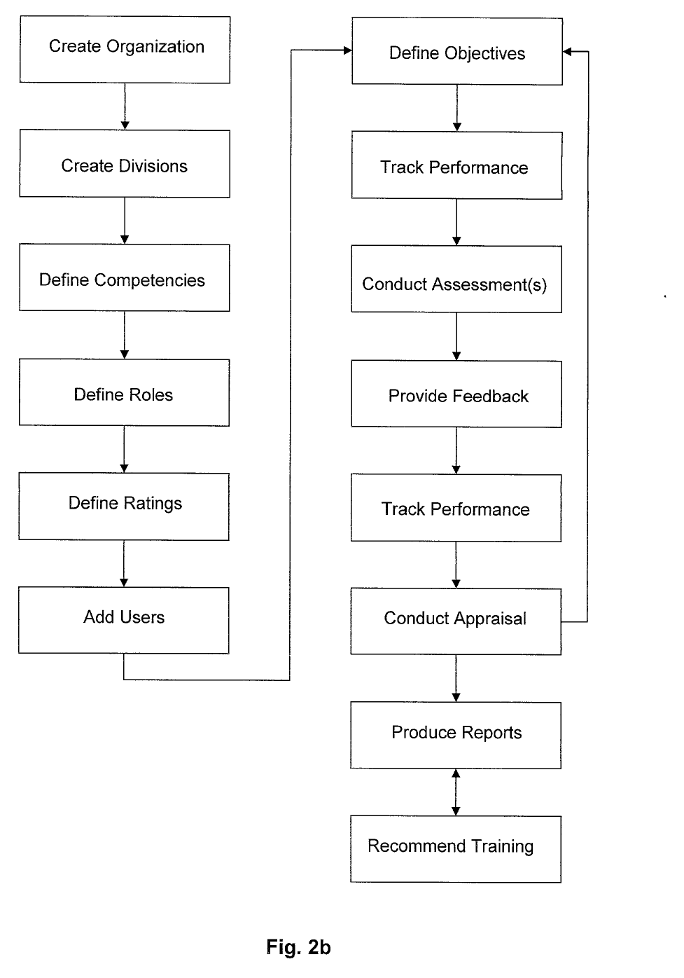

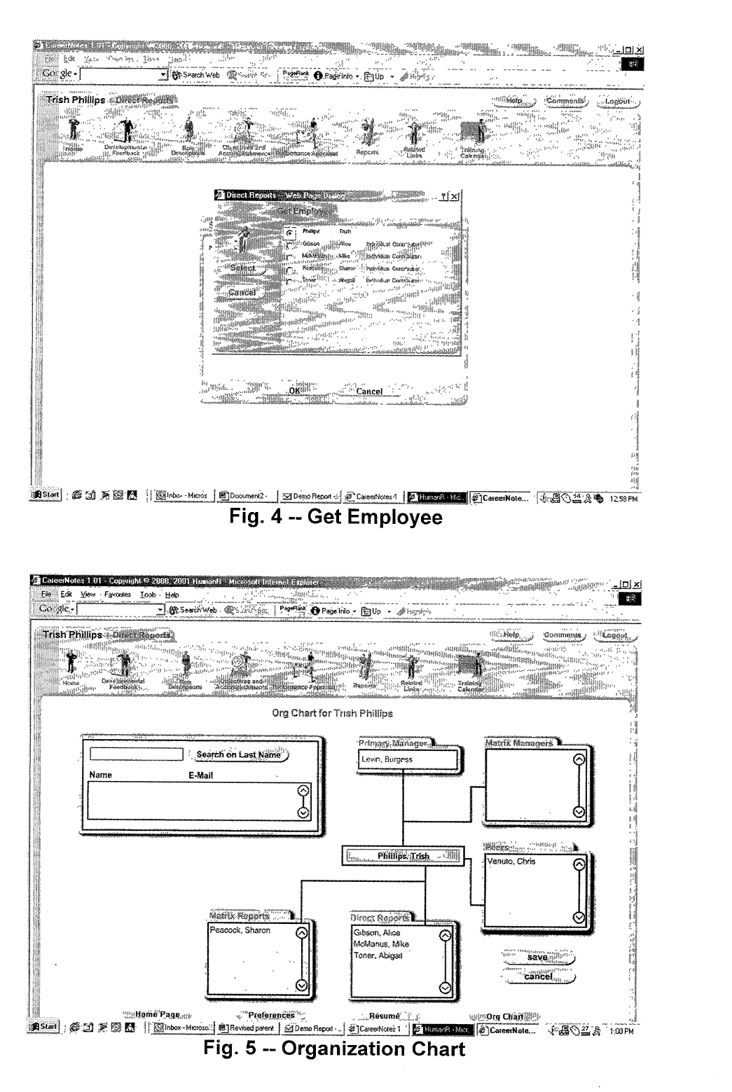

An embodiment of the present invention as shown in FIG. 2a comprises a method for on-line performance management comprising the steps of: defining the user's expected competencies; defining the user's role; inputting the new user; defining the user's objectives; and conducting the assessment on-line, in a web-based environment.

An alternative embodiment of the method according to the present invention is shown in FIG. 2b, and may comprise one or more of the following steps: creating an organization; creating divisions; defining ratings; tracking performance; providing feedback; conducting appraisals; producing reports; and recommending training, in addition to the steps of defining competencies, defining roles, adding users, defining objectives, and conducting assessments.

An alternative embodiment of the present invention comprises a method of initiating a self assessment in an on-line performance management system comprising the steps of initiating a self assessment; recording behavioral examples; saving the assessment as draft or sharing it with the manager; and comparing the results of the assessment on-line, in a web-based environment.

An alternative embodiment of the present invention comprises a method of initiating an assessment by a supervisor or manager in an on-line performance management system comprising the steps of: logging onto the system; initiating a multi-rater assessment for an employee; selecting users to provide the assessment; selecting the competencies to be assessed; receiving final feedback from the selected users; comparing the assessments of raters; selecting comments to import into the manager's final assessment; and saving the results as a draft or sharing them with the employee on-line in, a web based environment.

An alternative embodiment of the present invention comprises a method of initiating a 360 performance review in an on-line performance management system comprising the steps of: logging onto the system; initiating a request for 360 feedback selecting users to provide the assessment; and receiving compiled results in a 360 feedback report on-line, in a web based environment.

An alternative embodiment of the present invention comprises a method of generating a report in an on-line performance management system comprising the steps of: logging onto the system; initiating a request for a report; selecting report parameters; and displaying the report on-line, in a web based environment.

It will be apparent to those skilled in the art that various modifications and variations can be made in the construction, configuration, and/or operation of the present invention without departing from the scope or spirit of the invention. For example, within system 1, an access function may comprise identification means to confirm the identity of the user, and determination means to determine the level of access the user will be provided to the system 1. The access function may comprise a dialog box, a name text entry field, a password text entry field, a link to a help site, and a link to a logon site.

In an embodiment herein, the system and method of the present invention are implemented through a computer database structure. More specifically, an embodiment of the present invention is implemented in database form running on a series of networked computers and/or servers on the internal local area or wide area network of an organization. The various functions and processes of an embodiment of the present invention are carried out by the system of the present invention operating in a server environment in commercially available software. In an embodiment of the present invention, functional components and data of the present invention are stored in a table structure in an embodiment, the software of the present invention is written in Cold Fusion in a database/web server environment. The system may run Sequel Server 7.

In an embodiment of the present invention, active server pages are delivered by Cold Fusion through an application service provider or a company's internal servers to the users. The application also employs a number of other commercially available software formats comprising: Java Script, Flash, DHTML, and Microsoft Internet Explorer 5.0, and other application service provider software of a type known prior to the present invention in order to make the invention scalable. In this configuration, the server is adapted to deliver portions of the software components to the users, requiring the users to hit the server less frequently and reducing network traffic while maintaining all of the functionality and security features of a preferred embodiment of the method and system of the present invention. Other suitable systems may also be used.

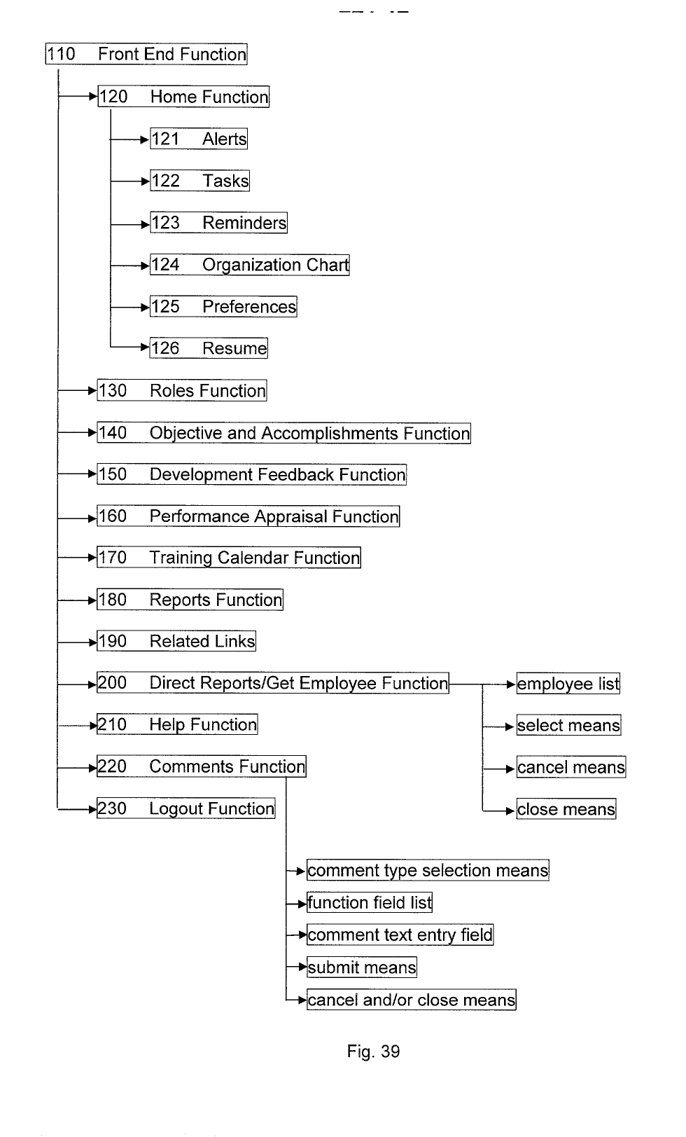

As shown in FIG. 39 and FIG. 6, according to an embodiment of the system of the present invention, following access to the front end module 110, user selectable links preferably include links to other software functions within system 1, comprising: home function 120, roles function 130, objectives and accomplishments function 140, developmental feedback function 150, performance appraisal function 160, training calendar function 170, reports function 180, related links function 190, direct reports function 200, help function 210, comments function 220, logout function 230. The home function 120 includes links to the organization chart function 124, alerts function 121, reminders function 123, and tasks function 122, preference function 125, and resume function 126.

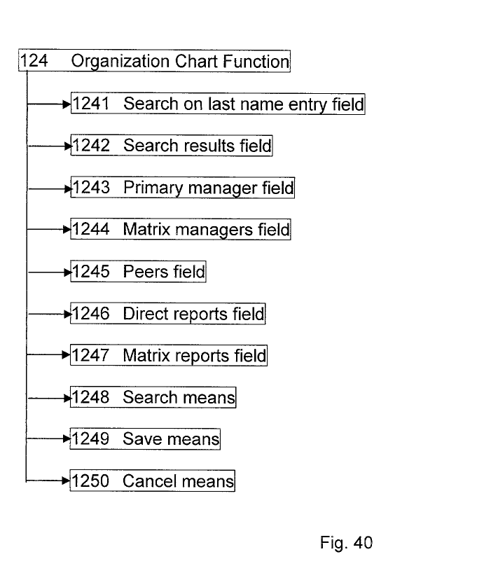

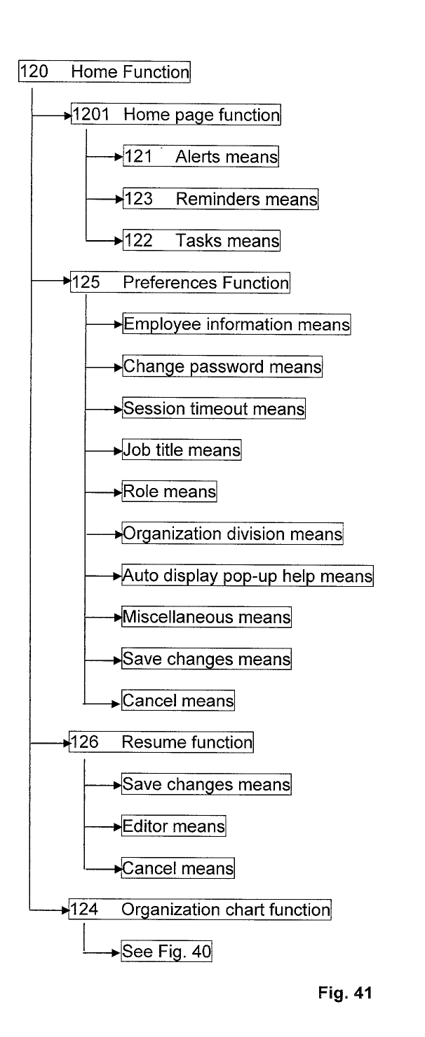

As shown in FIG. 40 and FIG. 5, the organization chart function 124 may further comprise search on last name entry field 1241, search means 1248, results field 1242, primary manager field 1243, matrix manager field 1244, peers field 1245, direct reports field 1246, matrix reports field 1247, save means 1249 and cancel means 1250.

Alert function 121 further comprises means for the system to alert users about actions affecting them taken by other users. Reminders function 123 further comprises means for the system to automatically reminder users about approaching deadlines for actions requested of them by other users. Tasks function 122 further comprises means for the system to automatically create a “to do” list for a user based on actions the user has established for him/herself or that other users have requested of him/her.

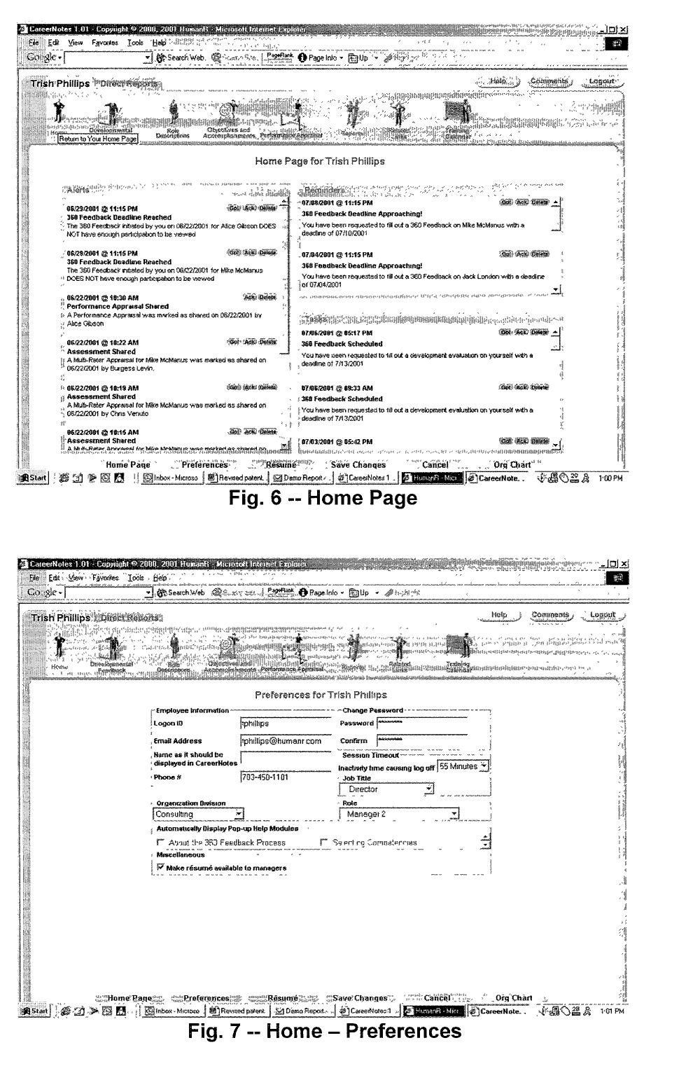

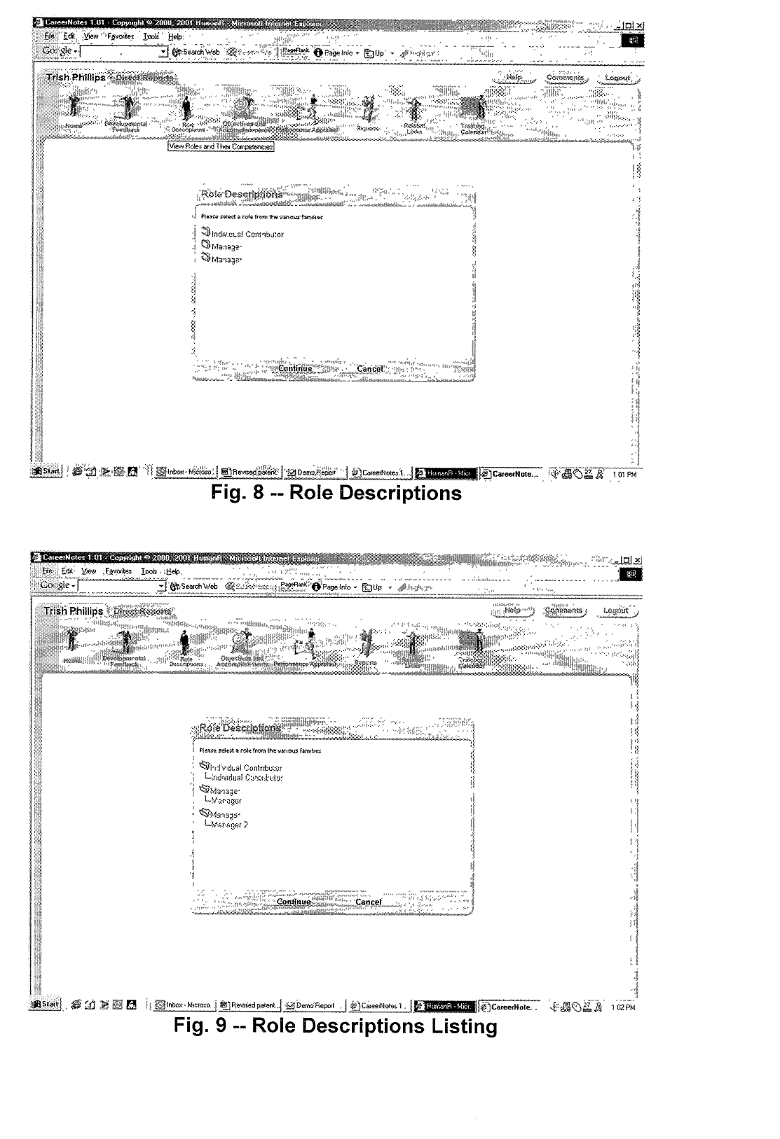

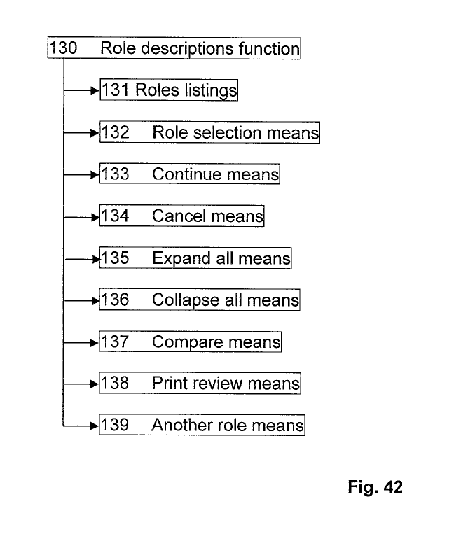

As shown in FIG. 41 and screen shot FIGS. 6 and 7, the home function 120 may further comprise home page function 1201, and user selectable links. Home function user selectable links further comprise preferences function 125, and resume function 126. As shown in FIG. 42 and FIGS. 8 and 9, roles function 130 further comprises role description function user selectable links. User selectable links comprise both default roles for the entire organization as well as division-specific roles function, which is customized for each enterprise user. Role descriptions function 130 may further comprise roles listing function 131, role selection means 132, another role means 139, expand all means 135, collapse all means 136, compare means 137, print means 138, continue means 133, and cancel means 134.

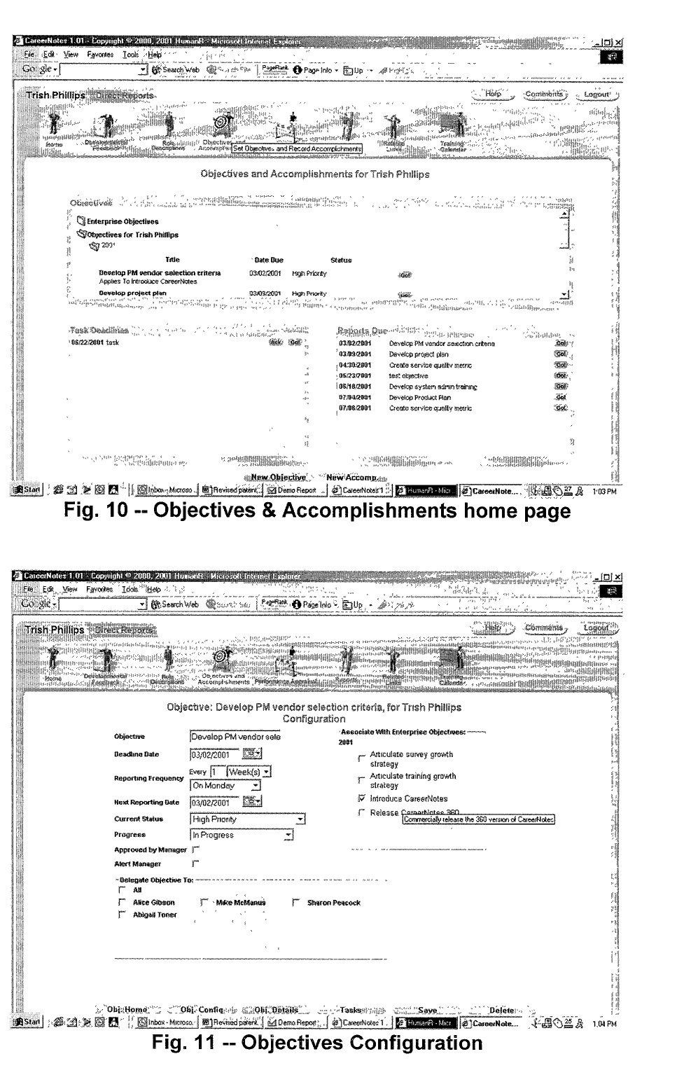

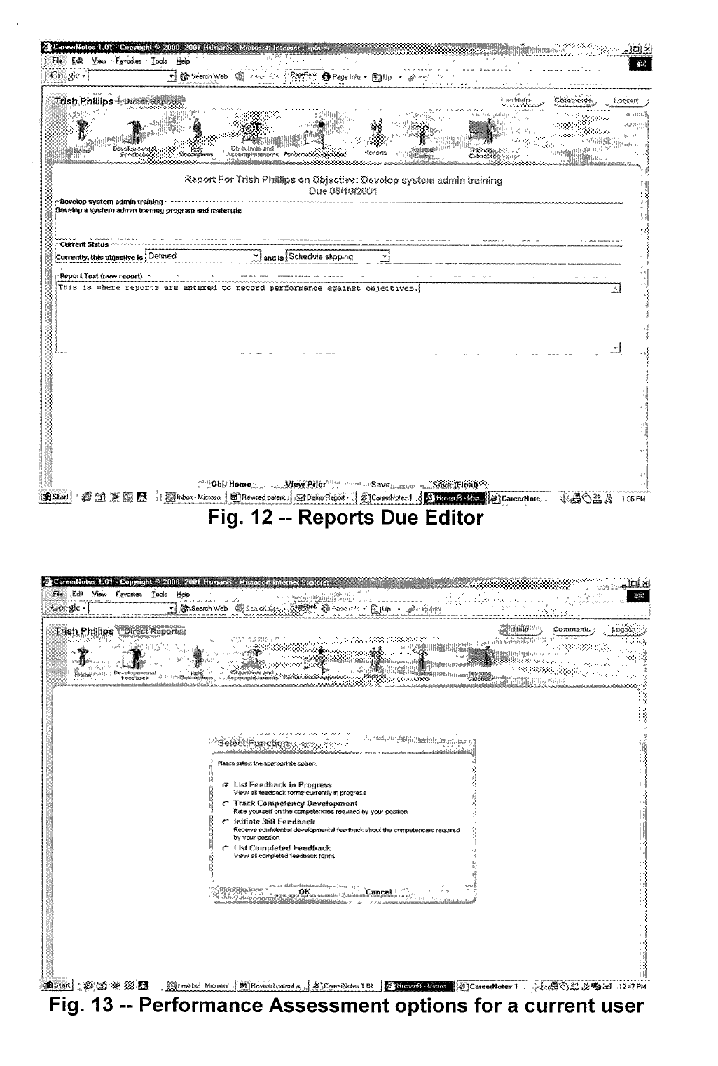

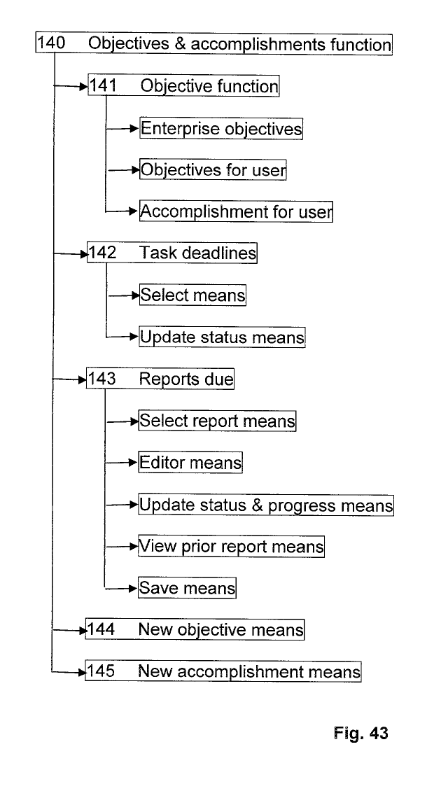

As shown in FIGS. 43 and 10-12, objectives and accomplishments function 140 may further comprise selectable objective function 141, new objectives function 144, new accomplishments function 145, the task deadlines field 142, and the reports due field 143. Objectives function 141 further comprises an enterprise objectives function, an objectives for user function, and an accomplishments for user function. Task deadlines 142 further comprises a select means and an update status means. Reports due function 143 further comprises a select report means, an editor means, and update status and progress means, a view prior report means, and a save means.

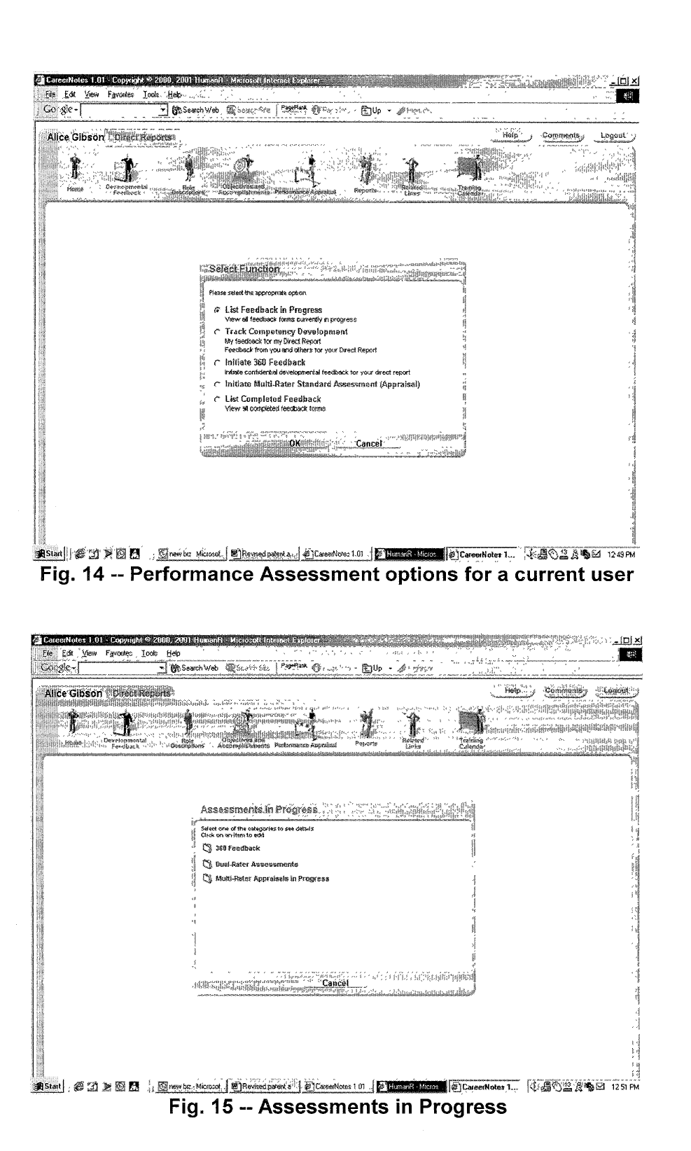

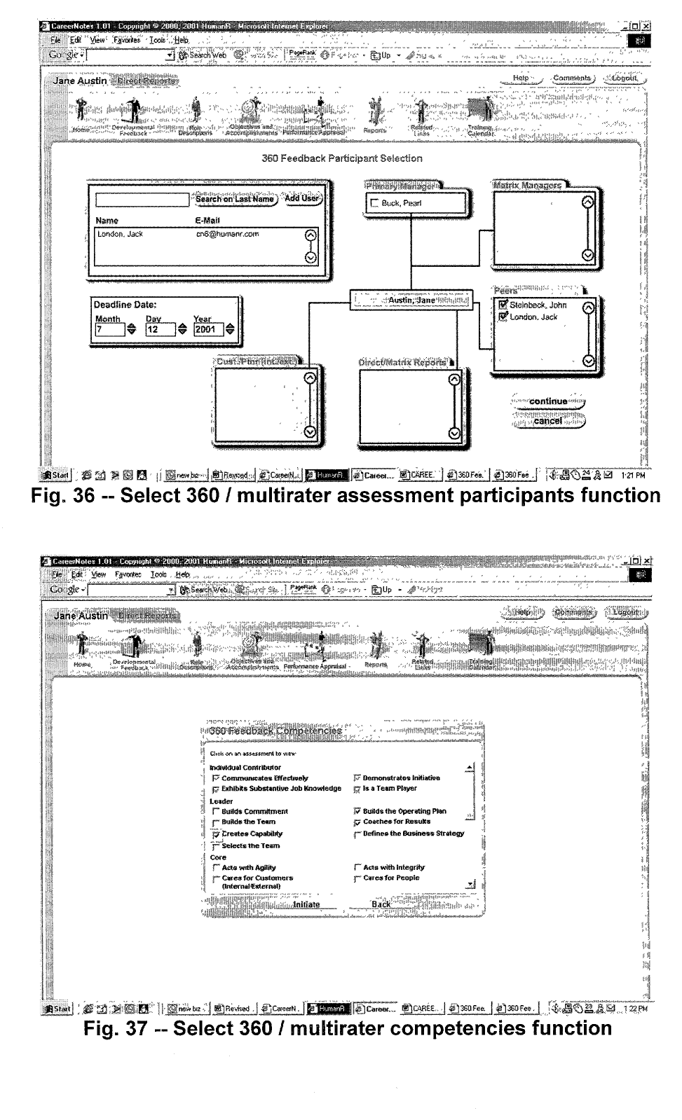

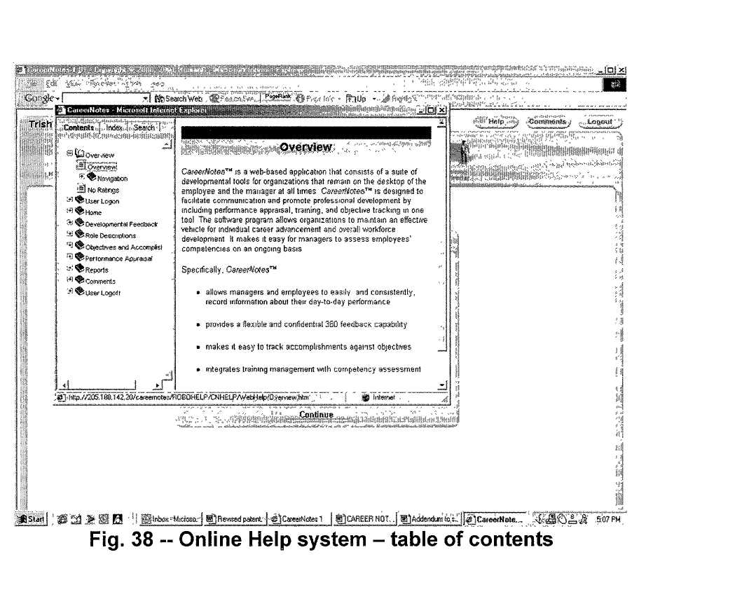

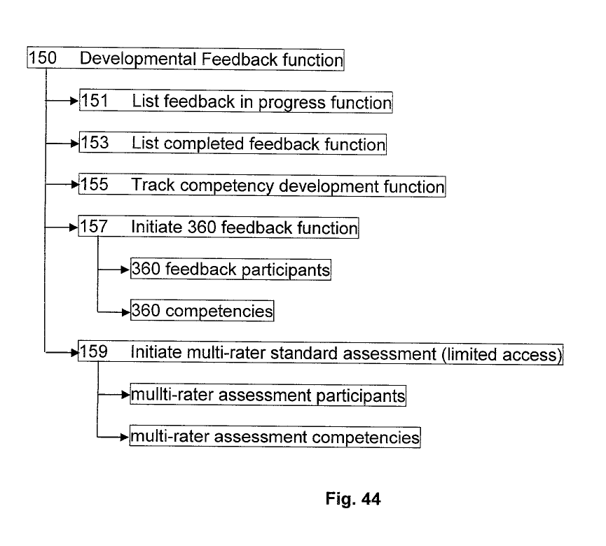

As shown in FIGS. 44 and 13, the developmental feedback function 150 may further comprise a list feedback in progress function 151, list completed feedback function 153, a track competency development function 155, and initiate 360 feedback function 157. As shown in FIGS. 44 and 14, the developmental feedback function 150 for managers further comprises an initiate multi-rater standard assessment function 159. As shown in FIGS. 44, 36 and 37, initiate 360 feedback function 157 may further comprise means for interactive 360 feedback assessments. As shown in FIG. 44, initiate 360 feedback function 157 further comprises multi-rater assessment participants function and/or 360 competencies function. The initiate multi-rater standard assessment function 159 further comprises multi-rater assessments participants function, and multi-rater appraisal competencies function.

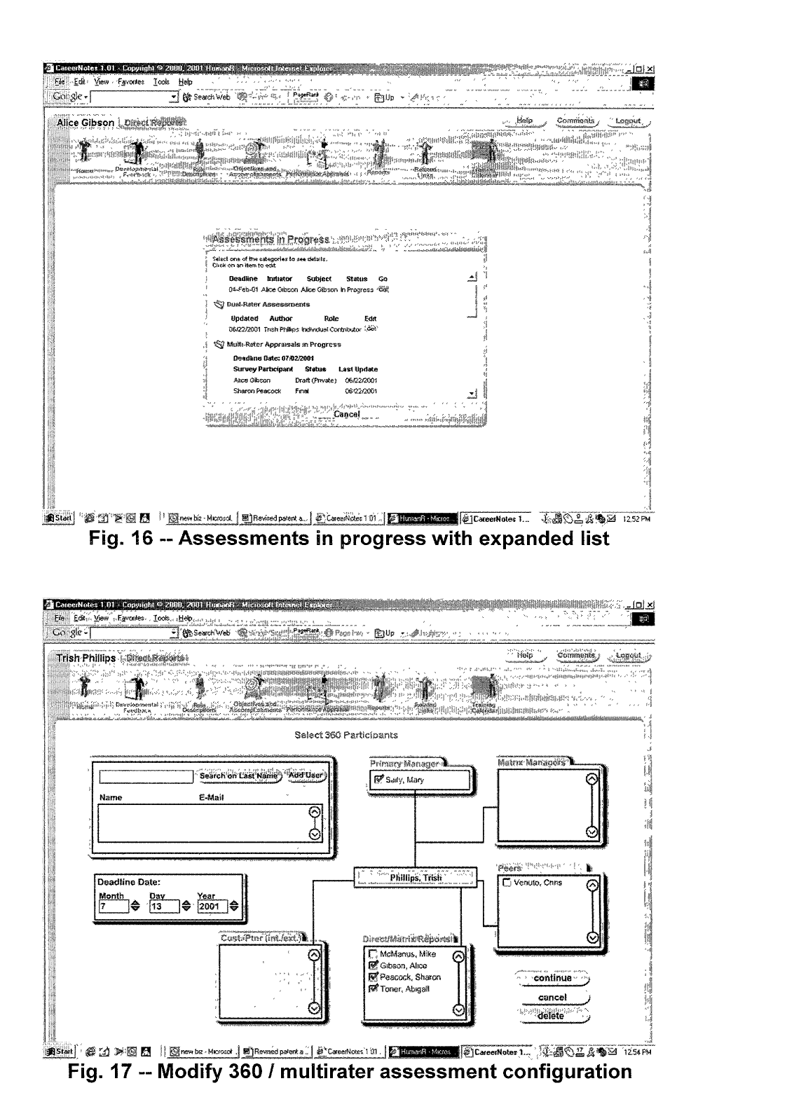

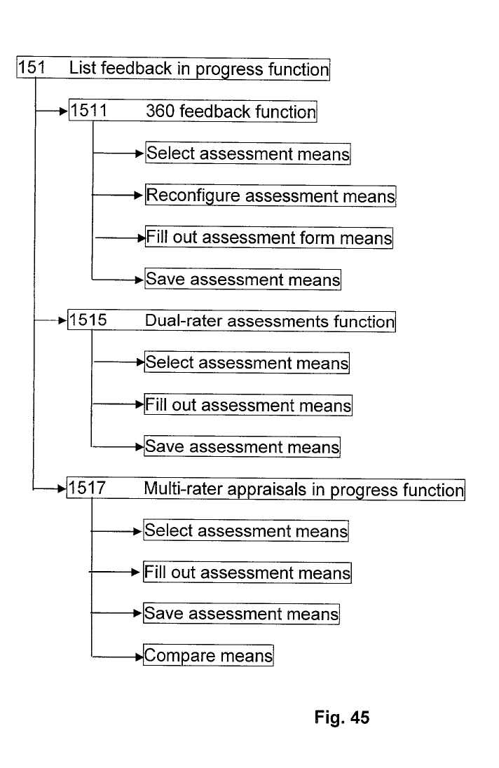

As shown in FIGS. 45, 15, and 16, list feedback in progress function 151 further comprises 360 feedback function 1511, dual-rater assessments function 1515, and multi-rater appraisals in progress function 1517. As shown in FIGS. 45 and 17, 360 feedback function 1511 may further comprise select assessment means, reconfigure assessment means, fill out assessment form means, and save assessment means. Dual rater assessments function 1515 may further comprise select assessment means, fill out assessment means, and save assessment means. Multi-rater appraisals and progress function 1517 may further comprise select assessment means, fill out assessment means, save assessment means, and compare means.

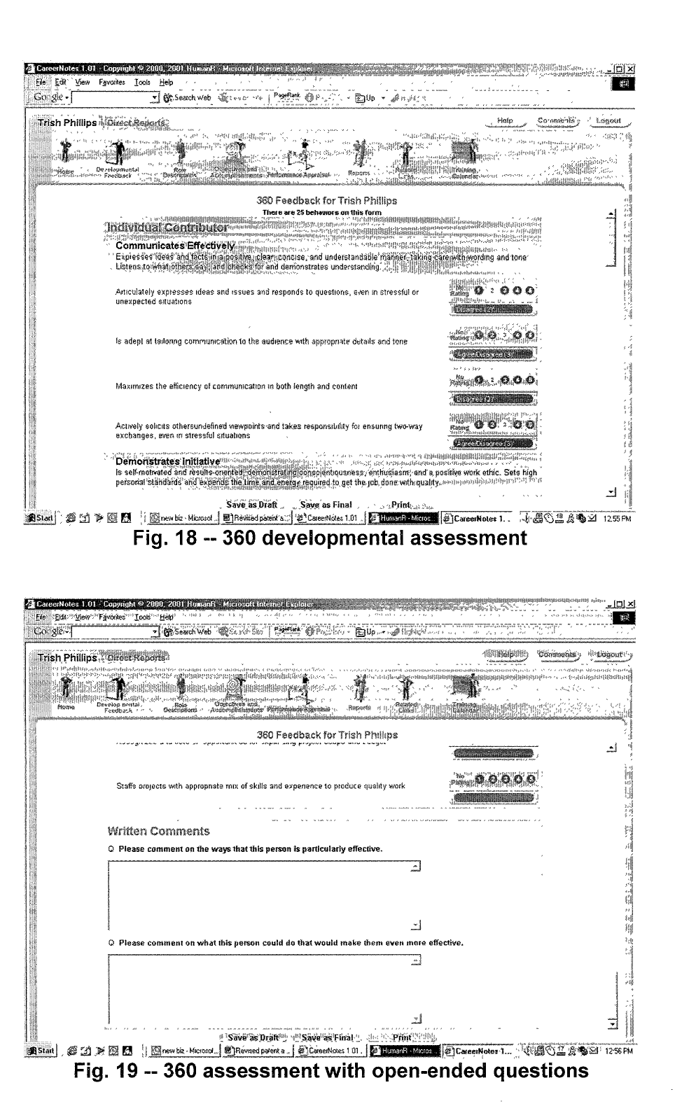

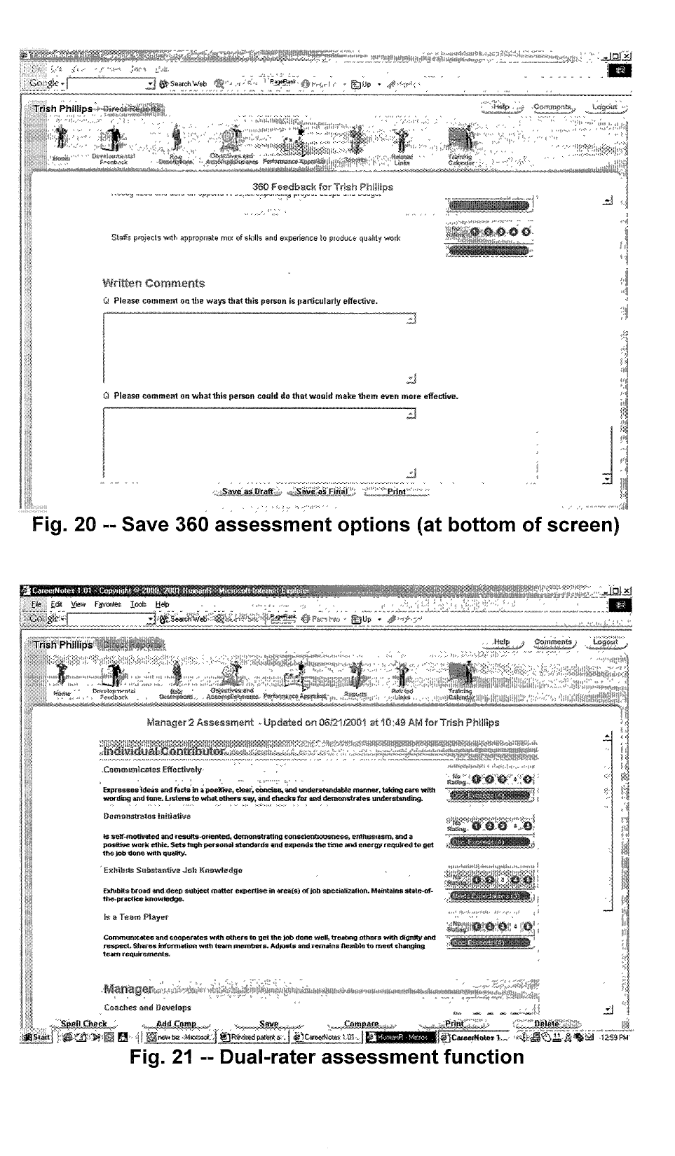

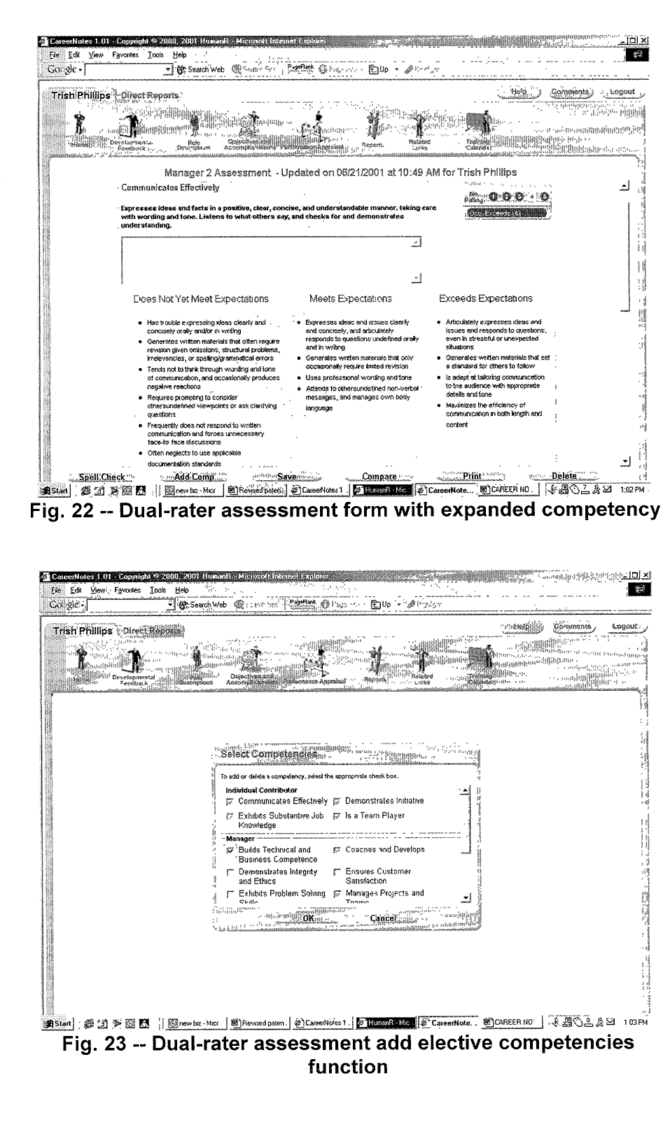

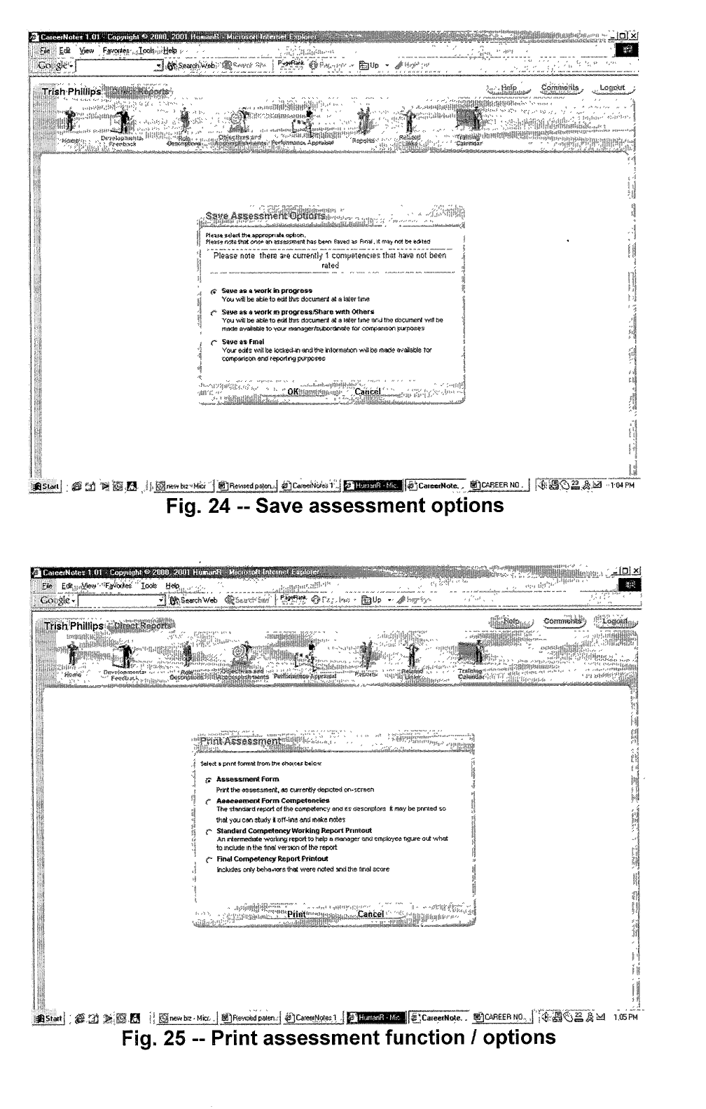

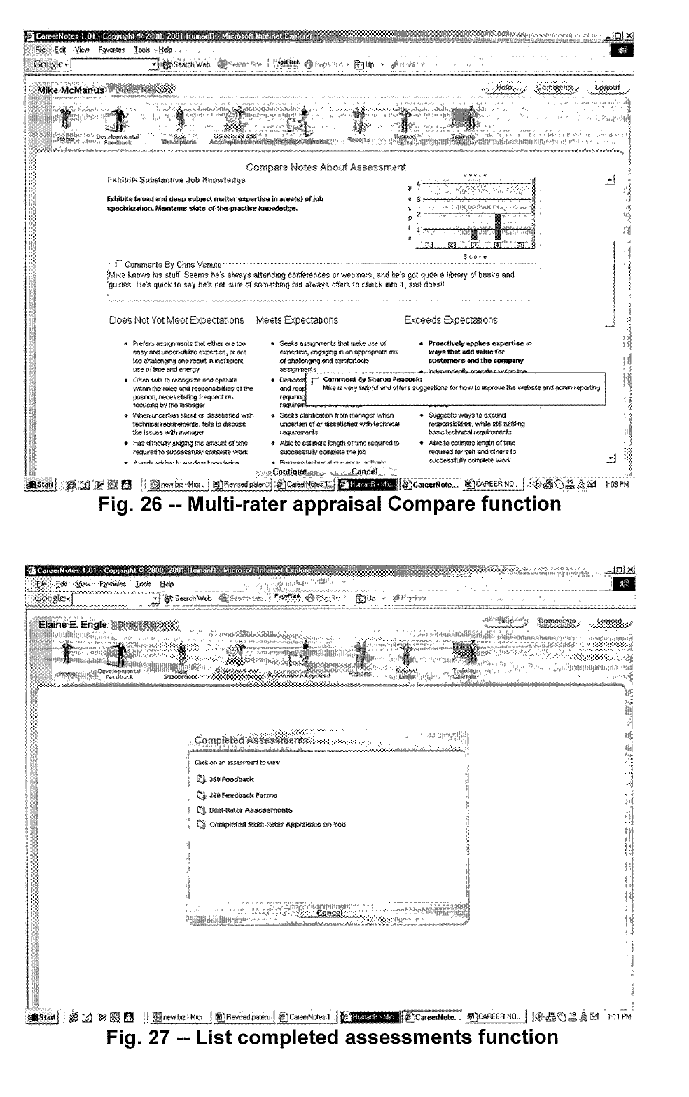

As shown in FIGS. 45 and 18-20, 360 feedback function 1511 preferably further comprises an interactive competencies rating function. The interactive competencies ratings function provides means for the user to rate the performance of others in predetermined performance categories. As shown in FIGS. 45 and 21-26, dual-rater assessments function 1515 further comprises an interactive competencies and expectations tracking function. Competencies and expectations function provides means for the user to rate and record comments on the performance of oneself or others. The multi-rater appraisals in progress function 1517 further comprises means to gather input from one or more users.

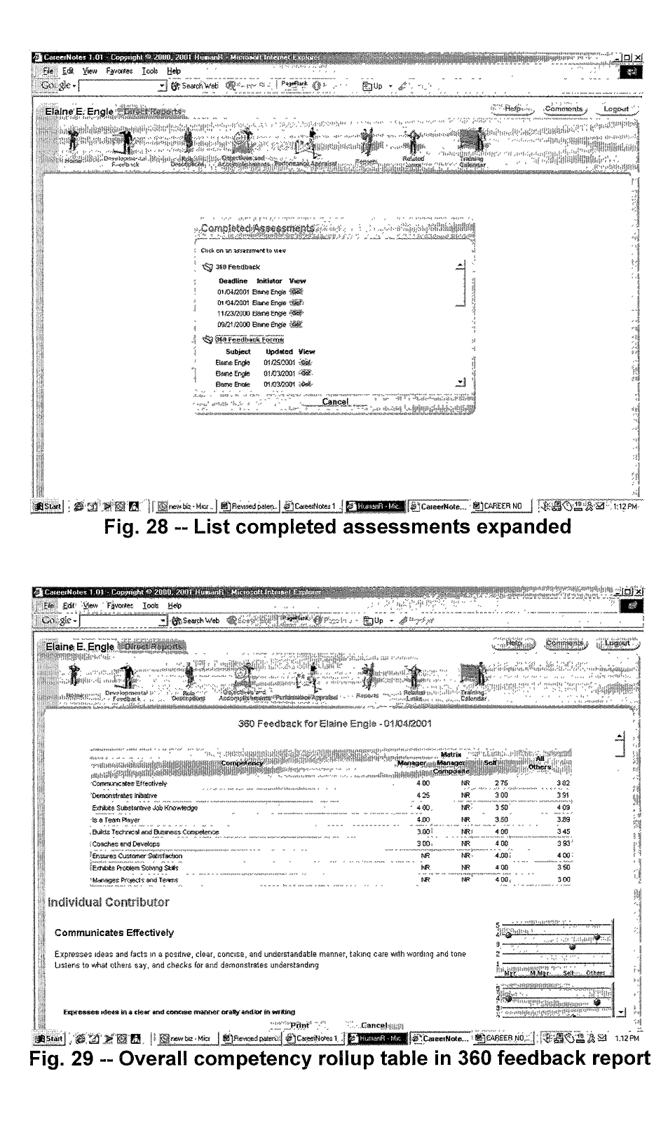

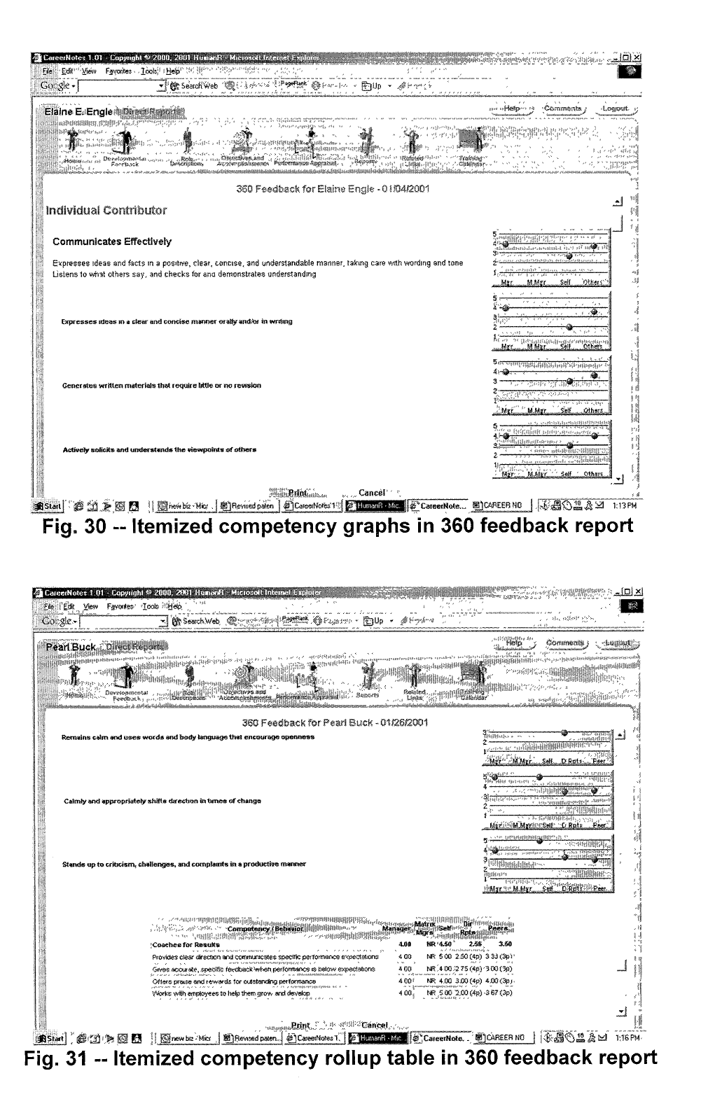

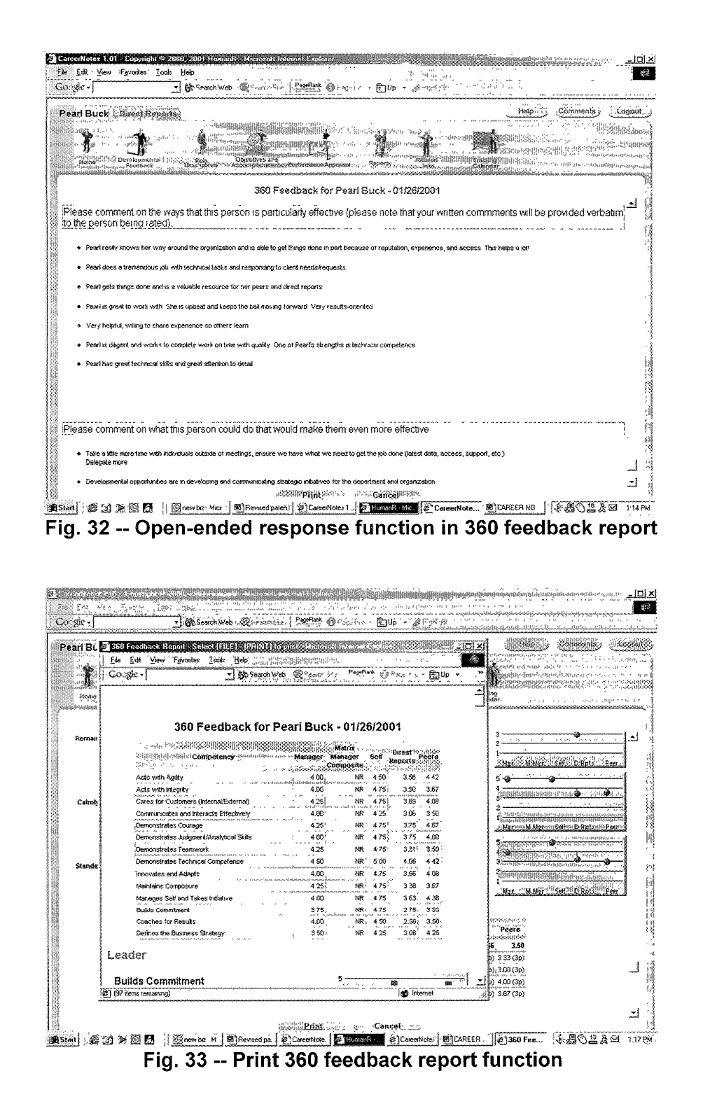

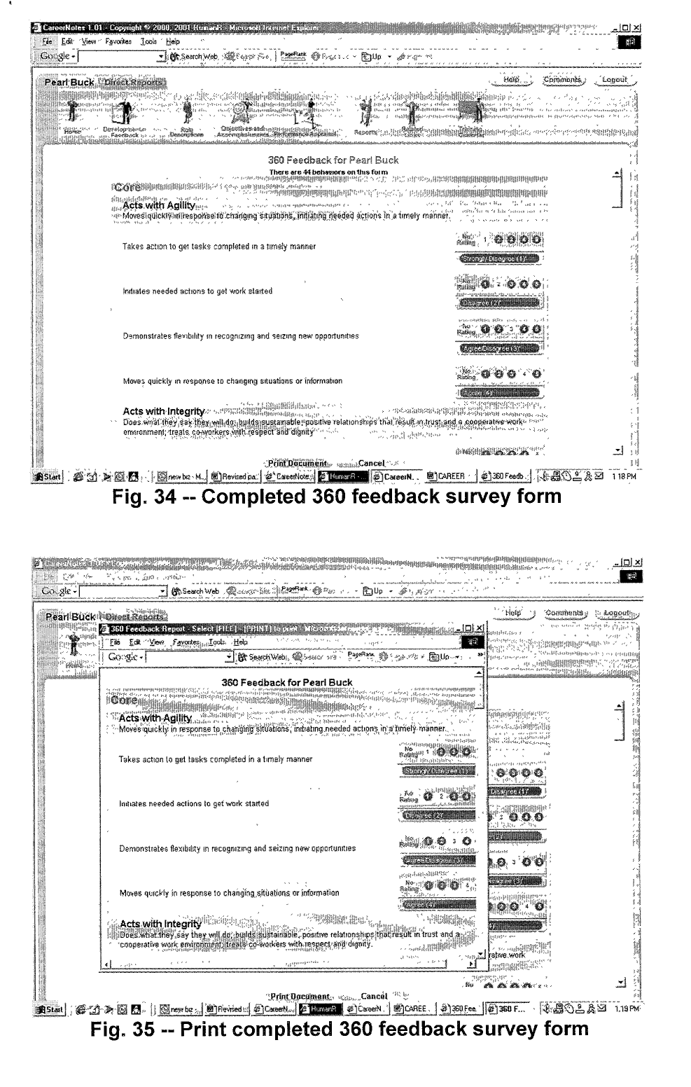

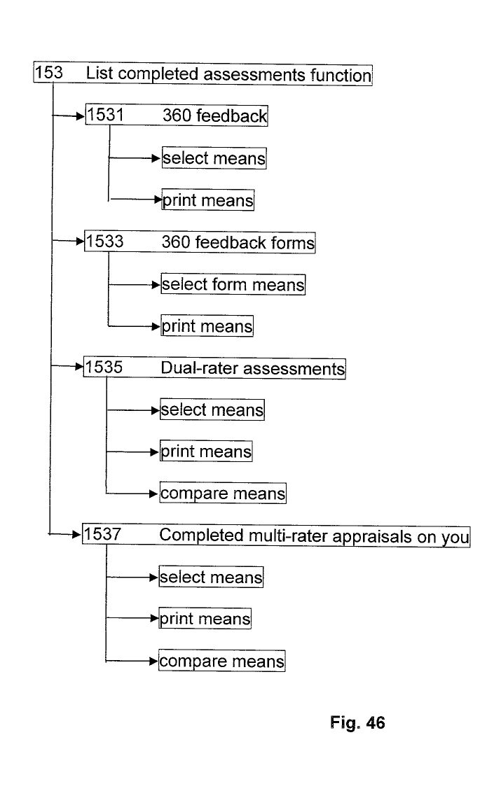

As shown in FIGS. 46 and 27-35, list completed assessments function 153 further comprises 360 feedback assessments function 1531, 360 feedback forms function 1533, dual-rater assessments function 1535, and completed multi-rater appraisals on you function 1537. The 360 feedback function 1531 and 360 feedback forms function 1533 may further comprise select means and print means. Dual rater assessments 1535 and completed multi-rater appraisals on you 1537 may further comprise select means, print means, and compare means.

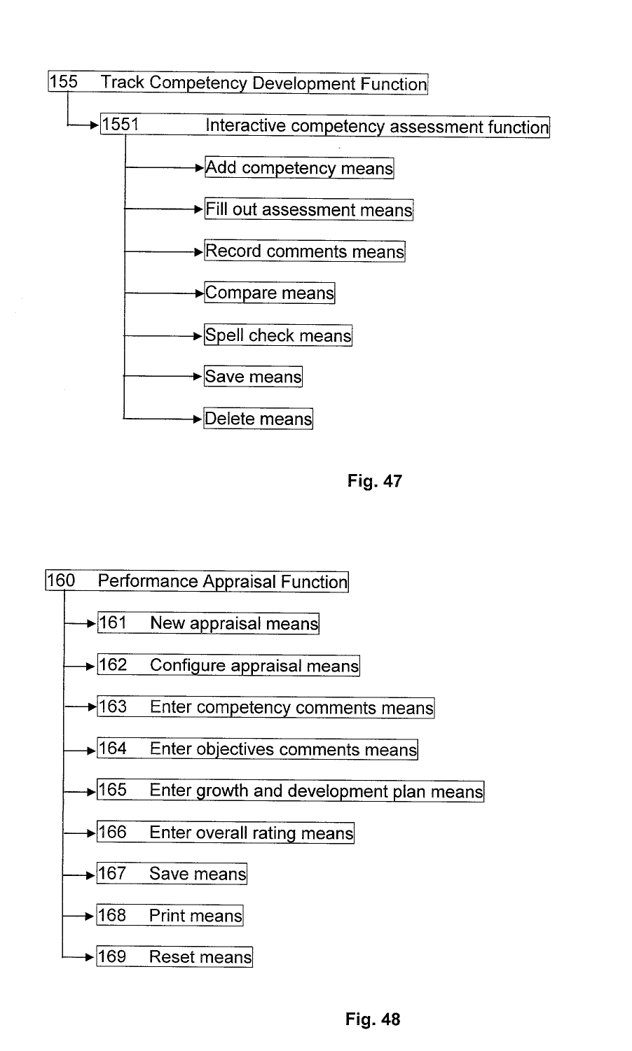

As shown in FIG. 47, the track competency development function 155 may further comprise an interactive competency assessment function 1551. Interactive competency assessment function 1551 may further comprise add competency means, fill out assessment means, record comments means, compare means, spell check means, save means, and delete means.

As shown in FIG. 48, performance appraisal function 160 may further comprise new appraisal means 161, configure appraisal means 162, enter competency comments means 163, enter objectives comments means 164, enter growth and development plan means 165, enter overall rating means 166, save means 167, print means 168, and reset means 169.

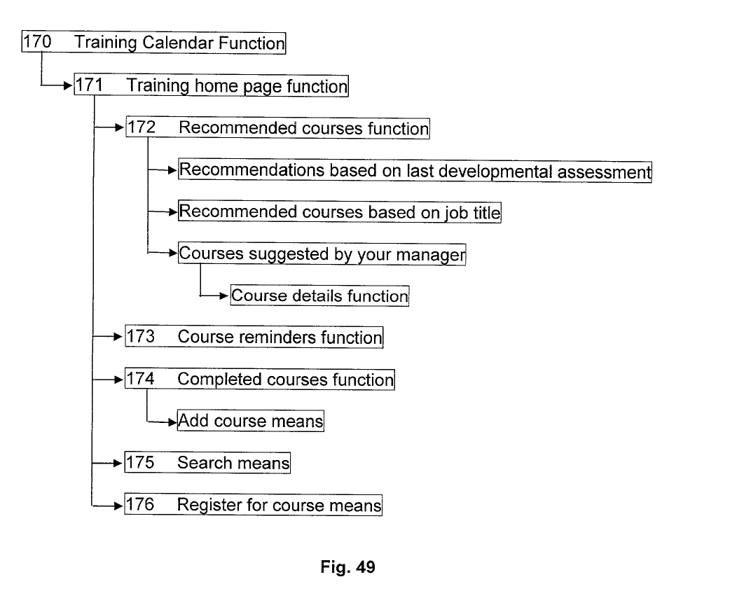

As shown in FIG. 49, training calendar function 170 may further comprise a training home page function 171, further comprising a recommended courses function 172, a course reminders function 173, a completed courses function 174, a search means 175, and a register for course means 176.

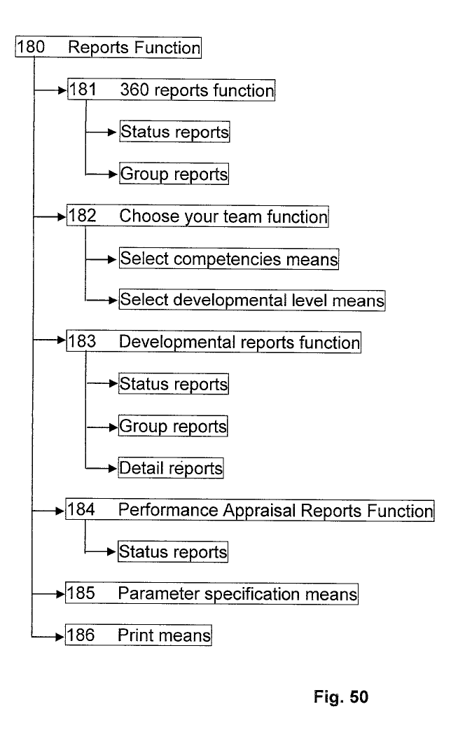

As shown in FIG. 50, reports function 180 may further comprise 360 reports function 181, choose your team function 182, developmental reports function 183, performance appraisal reports function 184, parameter specification means 185, and print means 186. 360 reports function 181 may further comprise status reports and group reports. Choose your team function 182 may further comprise select competency means and select developmental level means. Developmental reports function 183 may further comprise status report means, group report means, and detail report means, Performance appraisal reports function 184 may further comprise status reports means.

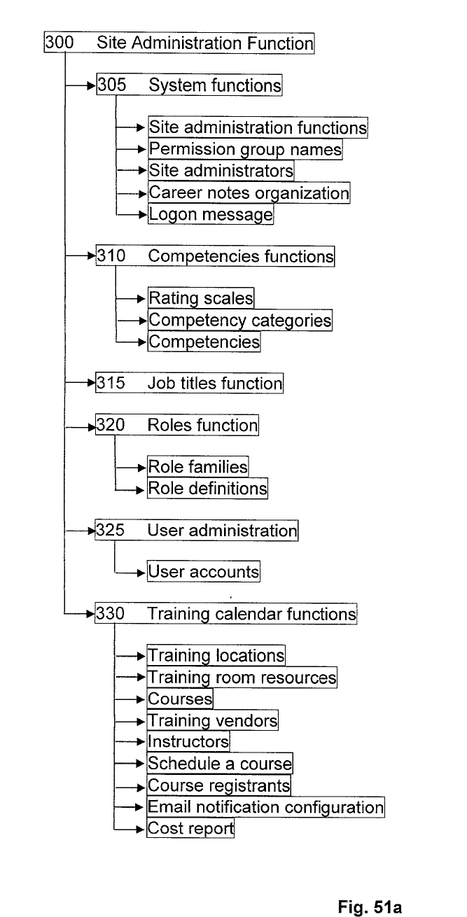

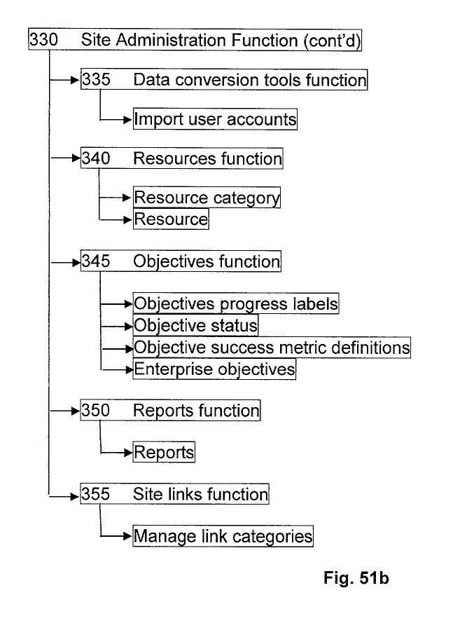

It will be apparent to those skilled in the art that various modifications and variations can be made in the construction, configuration, and/or operation of the present invention without departing from the scope or spirit of the invention. For example, a site administration function 300, as shown in FIGS. 51a and b and 56-67, may further comprise system function 305, competencies function 310, job titles function 315, roles function 320, user administration 325, training calendar function 330, data conversion tools function 335, resources function 340, objectives function 345, reports function 350, and site links function 355. In an embodiment of the system of the present invention, the site administration function may further comprise a division setup function, an organization setup function, an enterprise level objective setup function, progress and status labels function, success metric entry function, and report generation function. Division setup function may further comprise customization of roles function, customization of competency categories function, customization of competencies function, customization of rating scales function, and customization of role families function. Customization of role families function may further comprise roles associated with role families function. Roles definition function may in turn further comprise a competencies defined by role for a division function. Competencies defined by role for a division function may further comprise available competency field and an appropriate behaviors field.

Within the system function 305, organization setup function displays the divisions established for one organization. FIG. 56 depicts an example. The organization/division hierarchy drive the customization of roles, competency categories, competencies and rating scales. Within the division setup function and organization setup function, as shown in FIGS. 56 and 57, an authorized user may create organizations and divisions within the system. Divisions within the organization may include, but are not limited to, marketing, investments, products, business affairs, CEO, CFO, communications, research, and any other division appropriate for an organization. The authorized administrator preferably also has the flexibility to add divisions within an organization to customize this field,

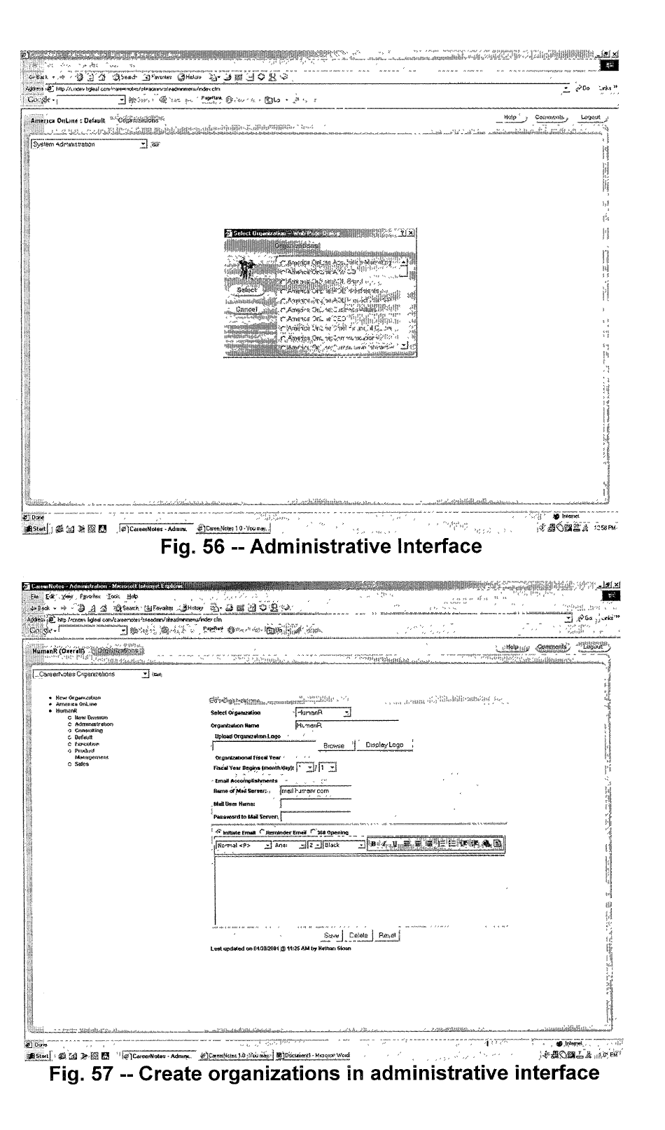

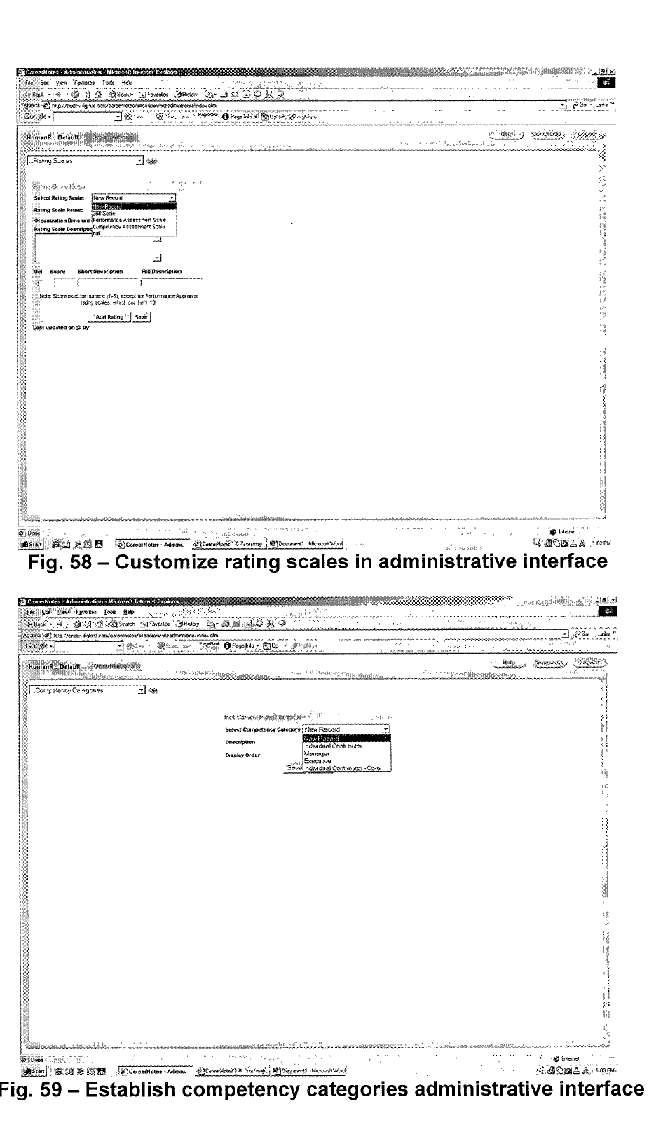

Within competency function 310, customization of rating scales function, as shown in FIG. 58, an authorized administrator may create and/or customize rating scales for the various assessment forms used within the division. Rating scales may include, but are not limited to: 360 scale; performance assessment scale; competency assessment scale; or a customized scale entered by the authorized user.

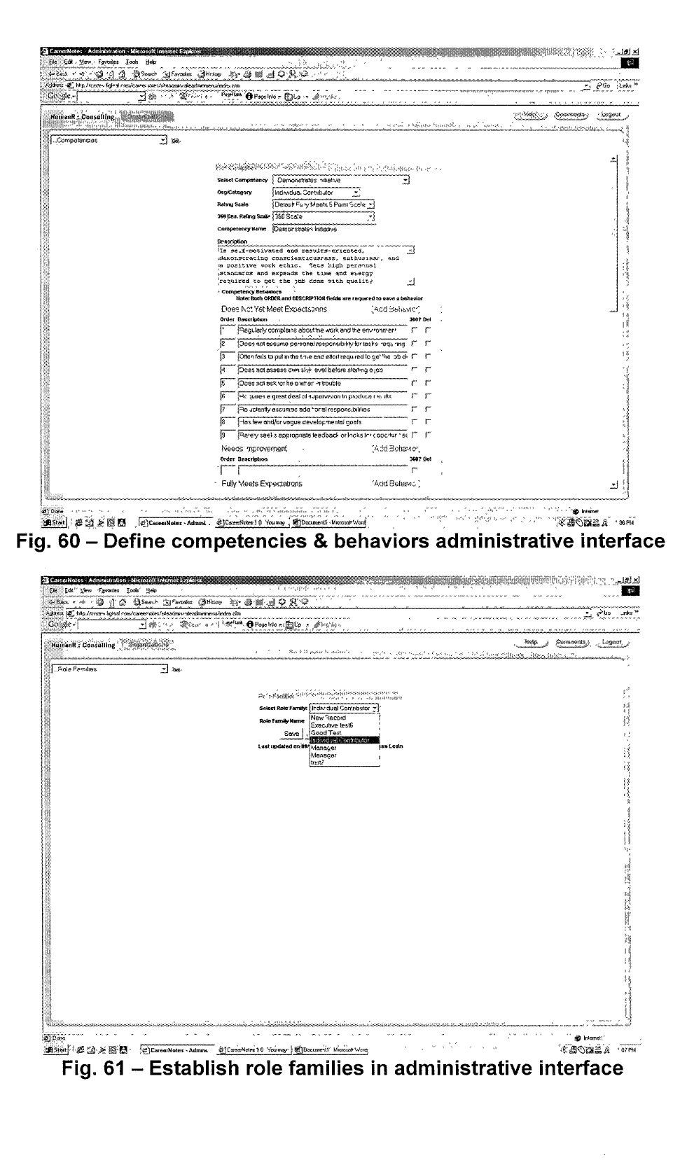

In the customization of competency categories function of competency function 310, as shown in FIG. 60, an authorized administrator may establish competency categories for each division. The system is preferably configured such that default division settings reload other divisions into the organizational hierarchy at system startup, and can be modified by division level authorized users. Competency categories may comprise: individual contributor; manager; executive; or the authorized administrator may create an independent and individual competency category appropriate to the organization.

In the customization of competencies function, of competency function 310, as shown in FIG. 61, an authorized user preferably establishes competencies and behavioral descriptors for each division. Competency is defined and a set of behaviors are listed that represent a range of performance within that particular competency. For example, in a “demonstrates initiative” competency, the description or definition of the competency may read “is self-motivated and result oriented, demonstrating conscientiousness, enthusiasm, and positive work ethic, sets high personal standards and expends the time and energy required to get the job done with quality.” The authorized administrator then loads a range of behaviors for users to select from which indicate that the employee is performing according to the defined rating scale, (e.g. does not meet expectations; needs improvement; fully meets expectations; or exceeds expectations.)

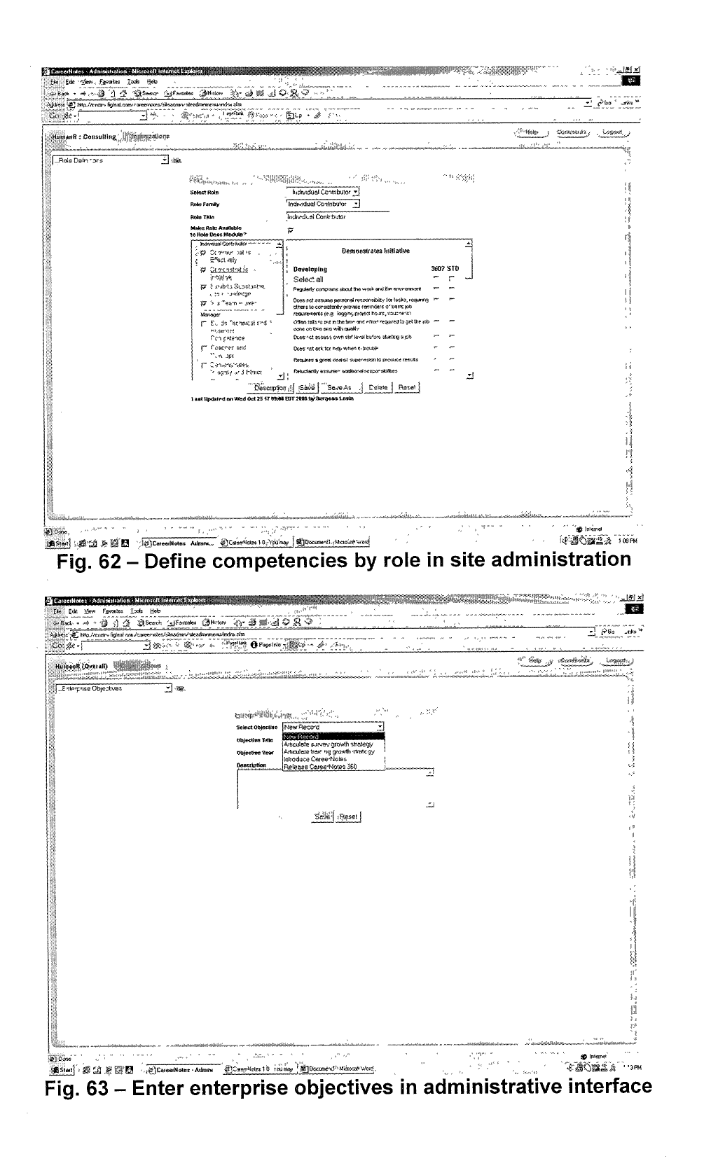

In customization of role families function, of roles function 320, as shown in FIG. 61, an authorized user establishes role families for an individual division. Roles are associated with role families and assigned competencies. Competencies may be defined by role for a division, as shown in FIG. 62, by selecting competencies that are listed within the system and checking the behaviors that are most appropriate for the role. For example, a project manager in the technology division might have a different definition for “communicates effectively” than a project manager in the sales division.

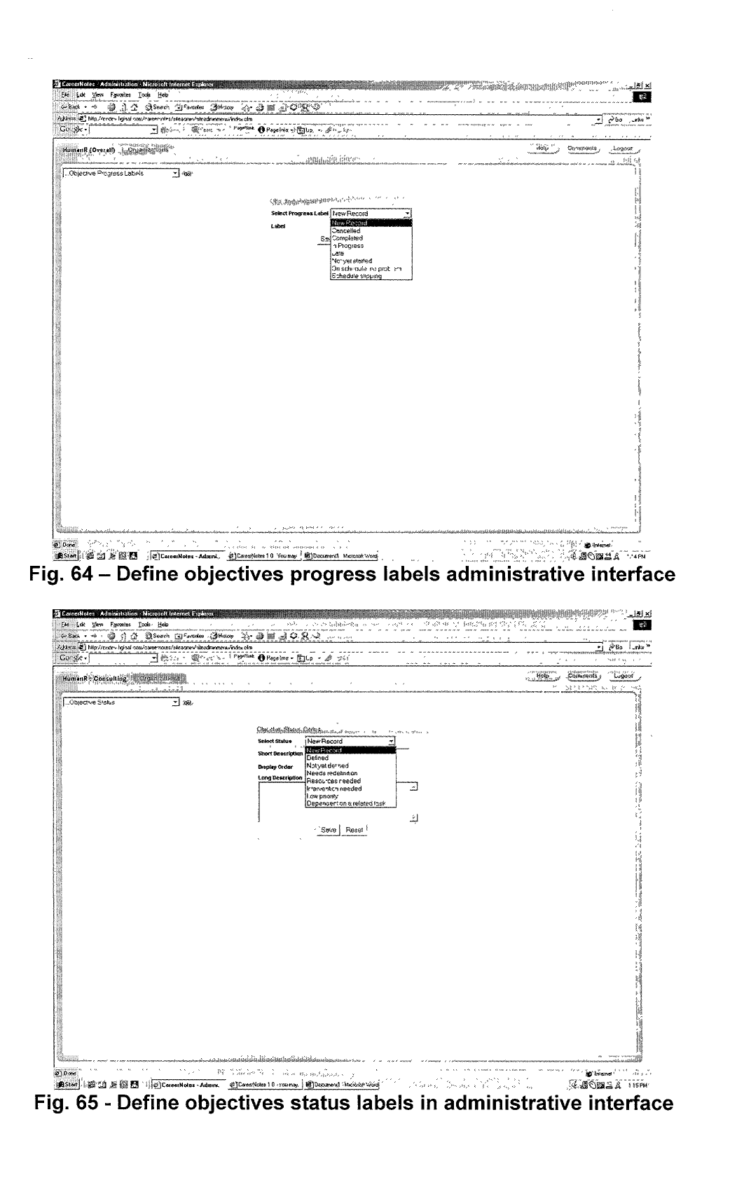

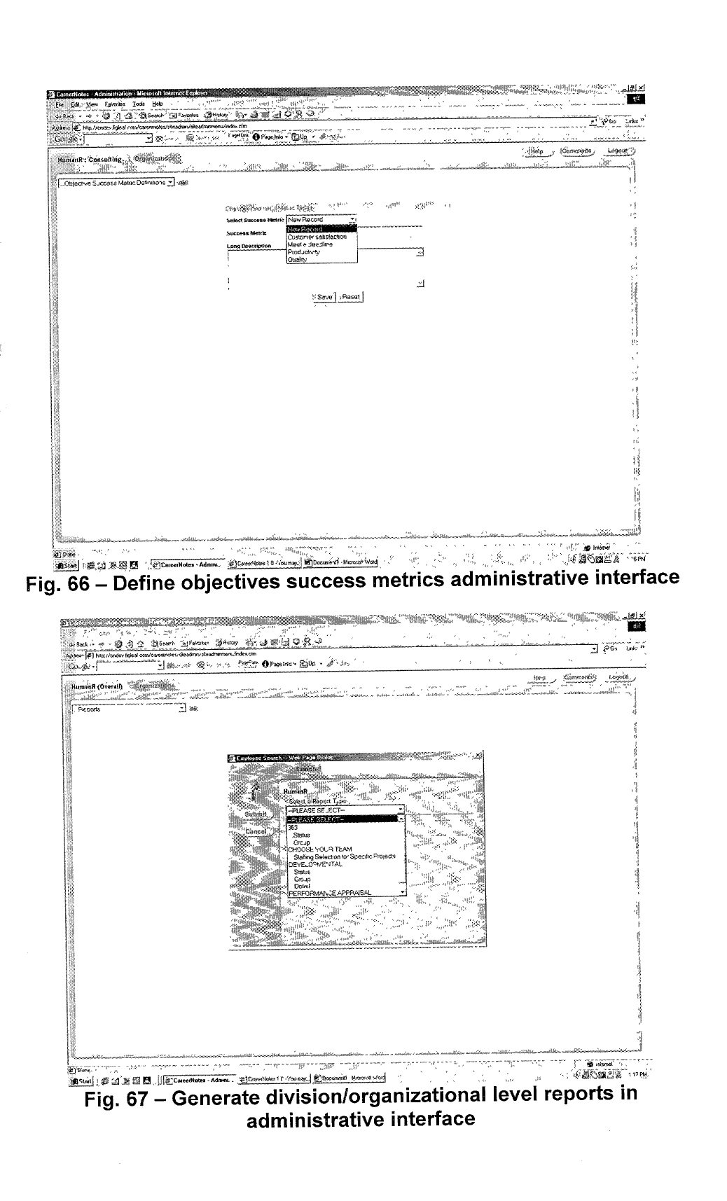

In the enterprise level objective setup function, of objective function 345, as shown in FIG. 63, an authorized user may establish corporate or enterprise level objectives for the entire organization. These objectives display in the users' Objectives & Accomplishments page and can be associated with individual objectives to drive alignment. In the progress and status labels, as shown in FIGS. 64 and 65, the authorized user may establish progress and status labels for reporting work against objectives in the user interface. These fields are archived along with the reports made available for review by the manager both within the objectives function and the performance appraisal function of the system. Status and progress labels are customized for each enterprise to reflect the language used by employees when reporting progress on objectives. In the success metrics entry function, as shown in FIG. 66, the authorized user may establish the success metric for objectives. Success metrics are customized for each enterprise to reflect the language used by employees when reporting on objectives achievement. In the report generation function 350, the authorized administrator can generate division and/or organizational level reports based on the authorized administrator's level of authorization.

In an alternative method according to an embodiment of the present invention, as shown in FIG. 2b, the method may further comprise one or more of the steps of: creating an organization; creating divisions; defining competencies; defining roles; defining ratings; adding users; defining objectives; tracking performance; conducting assessments; providing feedback; tracking performance; conducting appraisal; producing reports; and/or recommending training. These steps are by way of example only, and the method may comprise any one or more of these steps.

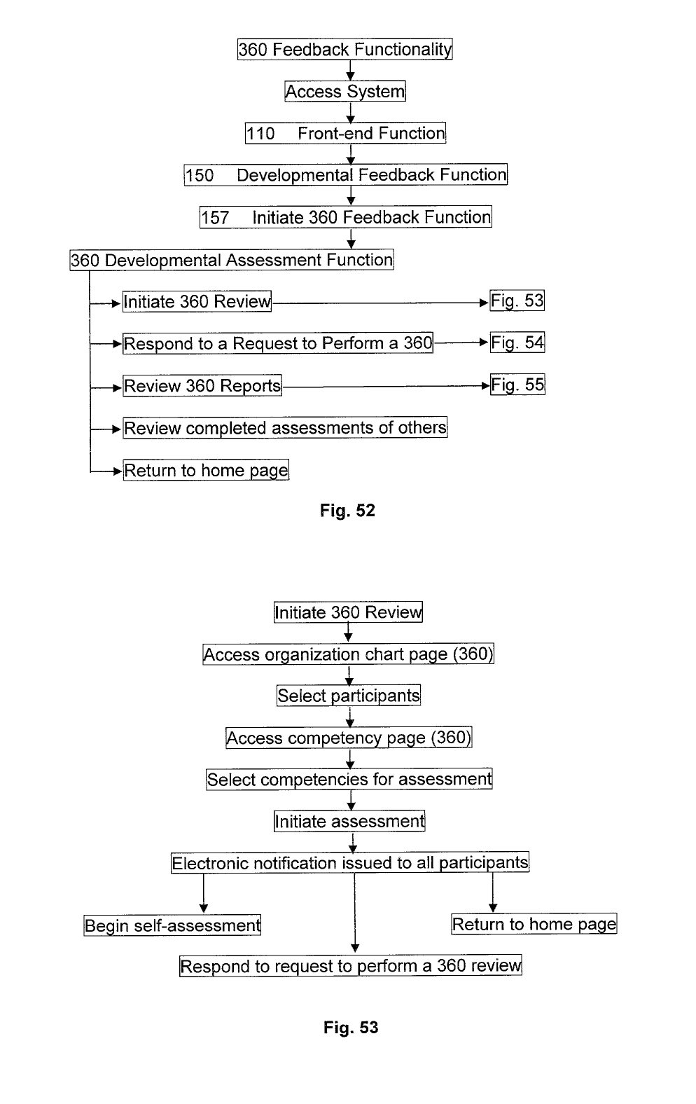

FIG. 52 illustrates a method according to an embodiment of the present invention wherein the user wishes to access the 360 feedback functionality. User accesses the system via the access function and enters front-end function 110. User then selects developmental feedback function 150, initiate 360 feedback function 157. In an alternative embodiment of the present invention, the user may be provided with 360 feedback selection means which transports the user directly to the 360 developmental assessment function. User selects the particular 360 feedback function desired in the 360 developmental assessment function main menu. User may select from: initiate 360 review; respond to request to fill out a 360; review 360 reports; review completed assessments of others; or return to home page.

To initiate a 360 review, the user selects initiate 360 review. As shown in FIG. 53, specific organization chart page is displayed. The user selects persons from the organization chart whom the user wishes to conduct the 360 review. Following selection of the review participants, specific competency page is displayed. The user selects the competencies to be included in the review using the competency selection dialog box on the competency page. Following selection of competencies, the user initiates the assessment. Electronic mail notification is sent to all the participants informing them of the assessment in progress, the closing date, and directing them to login and complete the assessment. The user may then choose to begin the self-assessment process, respond to a request to fill out a 360, or return to the home page.

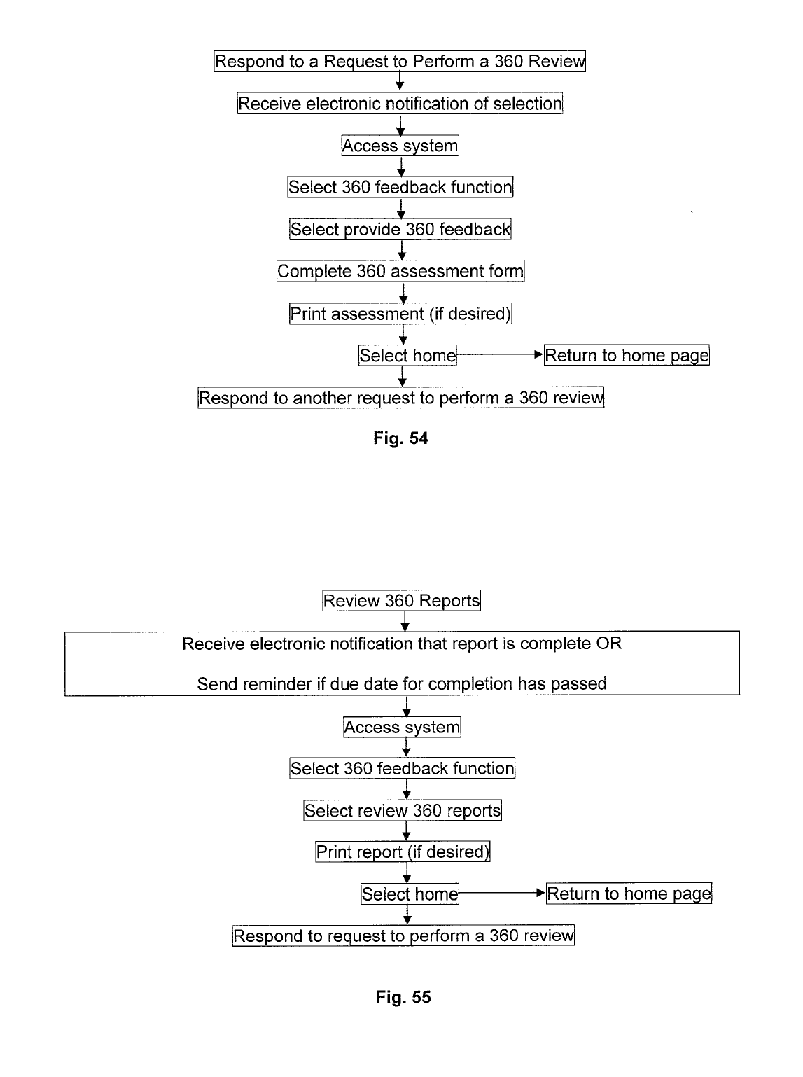

As shown in FIG. 52, the user may also respond to a request to fill out a 360 review. The user may respond by entering that function from the respond to request to fill out a 360, or may respond to a request to do a 360 as prompted by electronic mail notification. FIG. 54 illustrates the process when a user is notified by electronic mail of their participation in a 360 review. The user receives an electronic mail notification of the request to do a 360 review. The electronic mail notification may or may not include a direct link to the system access function. Once the user accesses in to the front end function 110, the user may select the 360 degree feedback function, if provided as a shortcut, or proceed through developmental feedback function 150, initiate 360 feedback function 157 as described above. Once in the 360 feedback function 157, the user selects respond to a request to fill out a 360 and selects the user's name to review, at which time the form is presented to the user and the user completes the form at the desktop. The user then prints the 360 assessment, if desired, or selects home. At this point, the user may respond to another request to complete a 360, or return to the home page.

As shown in FIG. 52, a user may also review 360 reports. The user directly enters from the review 360 reports function, or may request to review a report in response to electronic mail notification.

FIG. 55 illustrates the process of reviewing a 360 report, following notification by electronic mail. The user receives an electronic mail notification that the report is complete, or, in the alternative, the user receives a notification that the review due date has been extended. An electronic mail notification is issued to all participants reminding them of the request to perform a 360 review and of the new due date. If the review is complete the user is prompted to access the system through the access function. The user then selects development feedback function or enters the review 360 feedback reports function as described above. The user then reviews the report, and prints the report if desired. The user then selects home, at which time the user may respond to a request to complete a 360 or return to the home page.

The following example describes how reports are generated. Reports are preferably generated for 360 assessments, standard competency assessments, developmental reports, performance appraisal reports, and staffing reports. Various other reports are available in alternative preferred embodiments of the present invention and those listed are given only by way of example. Reports may be generated on the basis of one or more of various criteria, comprising: selection of a time frame; selection of the group or organization of interest; selection of how many levels down the report should illustrate; presentation of the data at an individual, group, or division level; display the proportion of assessments initiated versus those completed; display the number of assessments initiated; display total number of assessments completed; display proportion of assessments initiated versus assessments completed; display data in proportion to others within the group or organization; display data from individual's developmental assessments side by side; display data representing the similarities/differences between these scores; selection of how many prior assessments to include in report for comparison; display data from individual's prior developmental assessments side by side with current developmental assessment; display data representing the similarities/differences between these scores; display data by category or by item level ratings; selection to view strength by choosing a score cutoff point; select to view weaknesses by choosing a score cutoff point; select the number of categories to report; display all data in descending or ascending order; select the average group scores to determine overall strength and weaknesses of groups; display ratings comparison across multiple assessments for selection of criteria items; report data by individual/group to observe tendencies; report data as a histogram; display data by distribution of scores; or any other of a multitude of selection criteria which provide the report generator the ultimate flexibility and customization of reports on employee objective, competencies, development, and ratings. Thus, it is intended that the present invention cover the modifications and variations of the invention provided they come within the scope of the appended claims and their equivalents.

It will be apparent to those skilled in the art that various modifications and variations can be made in the construction, configuration, and/or operation of the present invention without departing from the scope or spirit of the invention as claimed. For example, in the embodiments mentioned above, various software and hardware may be employed to effect the methods and systems described above. The various embodiments of the invention, however, may be applied in many other interactive application environments without departing from the scope and spirit of the claimed invention. Furthermore, the types of applications for which the claimed invention may be used may be varied without departing from the scope of the invention. For example, the above-referenced methods and system may be used to facilitate a wide variety of human resources functions without departing from the spirit or scope of the claimed invention. Thus, it is intended that the present invention cover the modifications and variations of the invention provided they come within the scope of the appended claims and their equivalents.

We claim:

1. A system for on-line performance management comprising:
competency means for defining competencies;
objective means for defining objectives; and
assessment means for assessing performance based on said competencies and said objectives on-line in a web-based environment.

2. The system according to claim 1 further comprising role means for defining said competencies based on said roles, wherein assessment means for assessing performance is based on said competencies, said objectives, and said roles.

3. The system according to claim 1 further comprising development means for defining development and training recommendations based on said competencies and said objectives.

4. The system according to claim 1 further comprising 360 review means for providing 360 performance feedback.

5. The system according to claim 1, further comprising organizational chart means for defining users and their position within an organization.

6. The system according to claim 1, wherein said competency means further comprises the ability of a user to add competencies.

7. The system according to claim 1, wherein said objective means further comprises the ability of a user to add objectives.

8. A system for on-line performance management comprising:
competency means for defining competencies;
objective means for defining objectives;
role means for defining said competencies based on roles; and
assessment means for assessing performance based on said competencies, said objectives, and said roles.

9. The system according to claim 8, further comprising development means for defining development and training recommendations based on said competencies, said objectives, and said roles.

10. The system according to claim 8, further comprising 360 review means for providing 360 performance feedback.

11. The system according to claim 8, further comprising organizational chart means for defining users and their position within an organization.

12. A method for on-line performance management comprising the steps of:
inputting a user;
defining the user's expected competencies;
defining the user's objectives; and
conducting an assessment for assessing performance based on said competencies and said objectives on-line in a web-based environment.

13. The method according to claim 12, further comprising the step of defining the user's role.

14. The method according to claim 12, further comprising the steps of defining the user's role and conducting said assessment based on said competencies, said objectives, and said roles.

15. The method according to claim 12, further comprising the step of defining development and training recommendations based on said competencies and said objectives.

16. The method according to claim 13, further comprising the step of defining development and training recommendations based on said competencies, said roles, and said objectives.

17. The method according to claim 15, wherein said step of defining development and training recommendations further comprises the steps of:
recommending training and development activities;
allowing users to schedule training and development activities; and
maintaining a record of user training and development activities.

18. The method according to claim 12 further comprising the steps of:
initiating a request for an assessment;
selecting users to provide the assessment;
receiving the assessments from the selected users; and
compiling the results from the assessments on-line in a web-based environment.

19. The method according to claim 12 further comprising the steps of:
inputting objectives;
associating individual objectives with enterprise objectives;
selecting success metrics for objectives; and
establishing task milestones to complete objectives.

20. A method for on-line performance management comprising the steps of:
inputting a user;
defining the user's role;
defining the user's expected competencies;
defining the user's objectives; and
assessing the user's performance based on said competencies, said roles, and said objectives on-line in a web-based environment.
